(19) United States
(12) Patent Application Publication
(10) Pub. No.: US 2026/0352310 A1
(43) Pub. Date: Nov. 5, 2026

(54) Performing Beam Measurements for Hierarchical Beam Sweeping

(71) Applicant: Telefonaktiebolaget LM Ericsson (publ), Stockholm (SE)

(72) Inventors: Joao Vieira, Hjärup (SE); Muris Sarajlic, Malmö (SE); Sina Maleki (deceased); Hiroki Iimori, Kanagawa (JP); Jörg Huschke, Köln (DE); Stefan Adalbjörnsson, Hjärup (SE)

(21) Appl. No.: 19/115,489

(22) PCT Filed: Sep. 26, 2023
(86) PCT No.: PCT/EP2023/076565

§ 371 Date: Mar. 26, 2025

(30) Foreign Application Priority Data
Sep. 28, 2022 (WO) PCT/EP2022/077039
May 16, 2023 (SE) 23302227

(51) Int. Cl. H04B 7/06; H04B 7/0408; H04B 7/0456

(52) U.S. Cl. CPC H04B 7/06958; H04B 7/0408; H04B 7/0456

(57) ABSTRACT

Improvements in hierarchical beam sweeping are described to reduce overhead and/or improve performance in selecting the best beam. Instead of scanning the N beams in codebook Bₙ one-by-one, embodiments of the present disclosure scan linear combinations of the beams in the predefined codebook Bₙ and perform measurements on reference signals transmitted in the combined beams. Additionally, measurements performed in one or more previous stages can be used to aid in the selection of the best beam in the current stage.

### TECHNICAL FIELD

The present disclosure relates generally to beam management procedures in Fifth Generation (5G) networks and, more particularly, to improvements in hierarchical beam sweeping to reduce or improve beam measurements.

### BACKGROUND

Beam sweeping is beam management procedure carried out by a wireless device to identify and select the optimal beams for transmission and/or reception. Beam sweeping can be applied to both the downlink (DL) and the uplink (UL) directions, and at either the transmitter and/or receiver. For example, when applied in the downlink by a transmitting node, an access node transmits reference signals sequentially in a plurality of candidate beams. The user equipment (UE) measures the reference signals transmitted in each of the candidate beams and estimates the quality of the resulting downlink channels for each of the candidate beams. Traditional beam sweeping procedures typically yield a resource overhead equal to the number of candidate beams because reference signal measurements are performed on each candidate beam.

Beam sweeping can be performed in a hierarchical manner where the UE identifies a relatively wide beam in a first stage and refines the initial selection of the wide beam in subsequent stages to identify narrower beams with higher directional gain in each successive stage. In some scenarios, hierarchical beam sweeping can reduce beam measurements compared to sweeping and individually testing all beams of interest. As used herein, beam measurement refers to the measurement of reference signals or other signals in a serving beam, candidate beam, or target beam to determine beam quality.

Even with hierarchical beam sweeping, beam scanning in large antenna arrays would benefit from more efficient beam measurements because overhead scales with the number of candidate beams, which are typically proportional to the number of antennas. Additionally, beam selection in hierarchical beam sweeping is typically based on received signal strength. In some scenarios, the phase of received signals may also help detecting the optimal beam.

### SUMMARY

The present disclosure relates to improvements in hierarchical beam sweeping to reduce resource overhead and improve beam measurements. In conventional beam sweeping, a codebook Bₙ defines a set of beams to be measured at each stage of the beam sweeping procedure. Instead of scanning the N beams in codebook Bₙ one-by-one, embodiments of the present disclosure scan linear combinations of the beams in the predefined codebook Bₙ and perform measurements on reference signals transmitted in the combined beams. Additionally, measurements performed in one or more previous stages can be used to aid in the selection of the best beam in the current stage.

One aspect of the disclosure comprises methods of reducing beam measurements during hierarchical beam sweeping. In one embodiment, the method comprises computing a modified codebook Pₙ for a stage n>1 comprising K combined beam(s) based on a codebook Bₙ for stage n comprising N beams, wherein the K combined beams comprise linear combinations of the N beams in codebook Bₙ. The method further comprises, in stage n, measuring the K combined beam(s). The method further comprises selecting, for stage n, one of the K beams in codebook Bₙ based on a measurement of one or more beams performed in one or more previous stages and the K measurement(s) of the combined beam(s) performed in the stage n.

A second aspect of the disclosure comprises a wireless device configured to perform hierarchical beam sweeping. In one embodiment, the wireless device is configured to compute a modified codebook Pₙ for a stage n>1 comprising K combined beam(s) based on a codebook Bₙ for stage n comprising N beams, wherein the K combined beams comprise linear combinations of the N beams in codebook Bₙ. The wireless device is further configured to, in a second stage, measure the K combined beam(s). The wireless device is further configured to select, for stage n, one of the beams in codebook Bₙ based on a measurement of one or more beams performed in one or more previous stages and the K measurement(s) of the combined beam(s) performed in the stage n.

A third aspect of the disclosure comprises a wireless device configured to perform hierarchical beam sweeping. In one embodiment, the wireless device comprises communication circuitry for communicating with another radio network node using beamforming, and processing circuitry operatively connected to the communication circuitry. The processing circuitry is configured to compute a modified codebook Pₙ for a stage n>1 comprising K combined beam(s) based on a codebook Bₙ for stage n comprising N beams, wherein the K combined beams comprise linear combinations of the N beams in codebook Bₙ. The processing circuitry is further configured to, in a second stage, measure the K combined beam(s). The processing circuitry is further configured to select, for stage n, one of the beams in codebook Bₙ based on a measurement of one or more beams performed in one or more previous stages and the K measurement(s) of the combined beam(s) performed in the stage n.

A fourth aspect of the disclosure comprises a computer program for a radio node in a wireless communication system. The computer program comprises executable instructions that, when executed by processing circuitry in the radio node, causes the radio node to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

### BRIEF DESCRIPTION OF THE DRAWINGS

FIG. 1 illustrates beam sweeping in a wireless communication system using beamforming.

FIG. 2 illustrates wide and narrow beams used in hierarchical beam sweeping.

FIG. 3 illustrates an example of hierarchical beam sweeping according to conventional methods.

FIG. 4 illustrates an example of two-stage hierarchical beam sweeping according to an embodiment where K=N in the second stage.

FIG. 5 illustrates an example of two-stage hierarchical beam sweeping according to an embodiment where K<N in the second stage.

FIG. 6 illustrates an example of two-stage hierarchical beam sweeping according to an embodiment where K>N in the second stage.

FIG. 7 illustrates an exemplary method of hierarchical beam sweeping using a modified codebook at stage n.

FIG. 8 is a graph of the effective channel gain vs. SNR comparing different approaches to hierarchical beam forming.

FIG. 9A is a graph illustrating beam distribution according to one example embodiment using optimized weights.

FIG. 9B is a graph illustrating beam distribution according to one example embodiment using predefined weights.

FIG. 10 is a graph of simulation results comparing different approaches to hierarchical beam forming.

FIGS. 11A and 11B illustrate examples of reference signal timing for hierarchical beam sweeping according one embodiment where K<N in stage n.

FIG. 12A illustrates and example of reference signal timing for hierarchical beam sweeping according one embodiment where K=N in stage n.

FIG. 12B illustrates and example of reference signal timing for hierarchical beam sweeping according one embodiment where K>N in stage n.

FIG. 13 illustrates a method implemented by a radio node of hierarchical beam sweeping according to exemplary embodiments.

FIG. 14 illustrates an exemplary method of selecting a preferred beam at stage n in the hierarchical beam sweeping procedure using a modified codebook at stage n.

FIG. 15 illustrates a method implemented by a radio node of hierarchical beam sweeping using a reduced codebook where K<N.

FIG. 16 illustrates an exemplary method of selecting a preferred beam at stage n in the hierarchical beam sweeping procedure using a reduced codebook at stage n.

FIG. 17 illustrates an exemplary beam sweeping unit for a radio node configured to perform hierarchical beam sweeping using a reduced codebook.

FIG. 18 illustrates an exemplary radio node configured to perform hierarchical beam sweeping using a reduced codebook.

FIG. 19 shows an example of a communication system in accordance with some embodiments.

FIG. 20 is a block diagram of a host in accordance with various aspects described herein.

FIG. 21 shows a communication diagram of a host communicating via a network node with a UE over a partially wireless connection in accordance with some embodiments.

### DETAILED DESCRIPTION

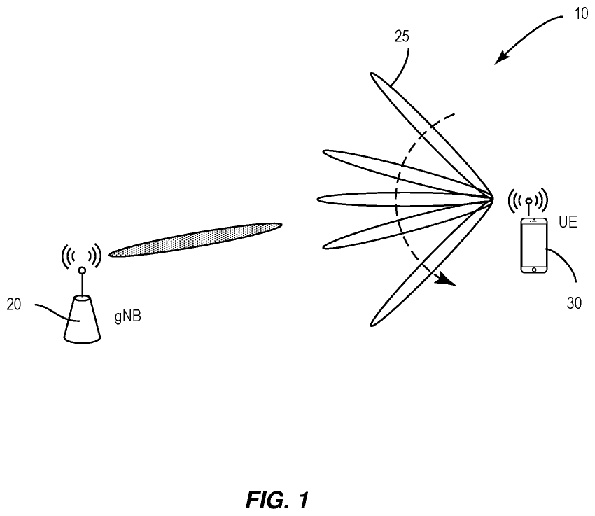

Beam sweeping is beam management procedure carried out by a radio network node in a wireless communication system to identify and select the optimal beams for transmission. The radio network node may comprise a user equipment (UE) or access node (e.g., base station). Beam sweeping can be applied to both the downlink (DL) and to the uplink (UL) directions, and at the transmitting node and/or receiving node. FIG. 1 illustrates beam sweeping performed on the downlink between an access node 20 and a user equipment (UE) 30. In this example the UE 30 is the receiving node and the access node 20 is the transmitting node.

The access node 20 transmits a reference signal in at least one transmit beam while the UE 30 performs beam sweeping and measures the reference signal(s) received in each candidate beam. FIG. 1 illustrates 5 candidate receive beams. Based on the reference signal measurements, the UE 30 estimates the quality of the resulting downlink (DL) channels for each of the candidate receive beams, selects the best receive beam, and optionally signals its selection to the access node 20. Traditional beam sweeping procedures typically yield a resource overhead equal to the number of candidate beams because reference signal measurements are performed on each candidate beam.

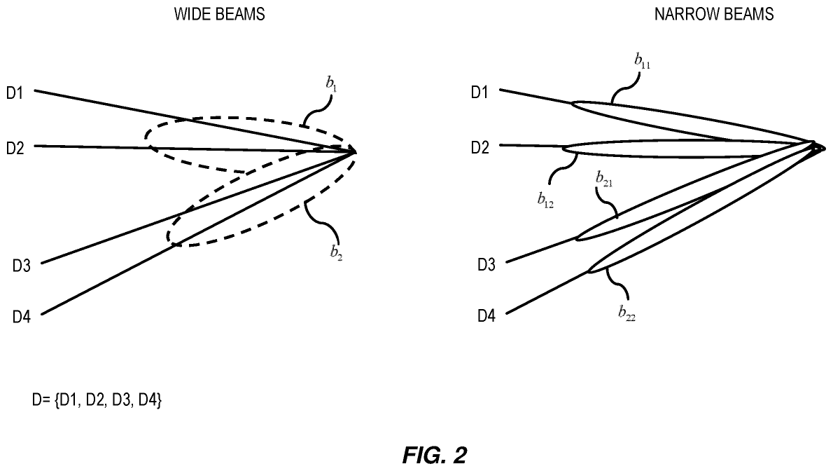

Beam sweeping can be performed in a hierarchical manner where the UE 30 identifies a relatively wide beam in a first stage and refines the initial selection of the wide beam in subsequent stages to identify narrower beams with higher directional gain in each successive stage. FIG. 2 illustrates an example of wide beams and narrow beams used in 2-stage hierarchical beam sweeping with 4 directions of interest denoted D1-D4 from which to select. FIG. 2 illustrates relatively wide beams b₁, b₂ to be used in the first stage and narrower beams b₁₁, b₁₂, b₂₁, and b₂₂ to be used in the second stage depending on the selected beam chosen in the first stage. Because the beams in the first stage are wide, a smaller number of beams are needed to scan the angular spectrum of interest. The goal of the UE 30 is to select one of the narrow beams that is the most suitable for communication (e.g., the beam yielding the largest link gain/receiver power).

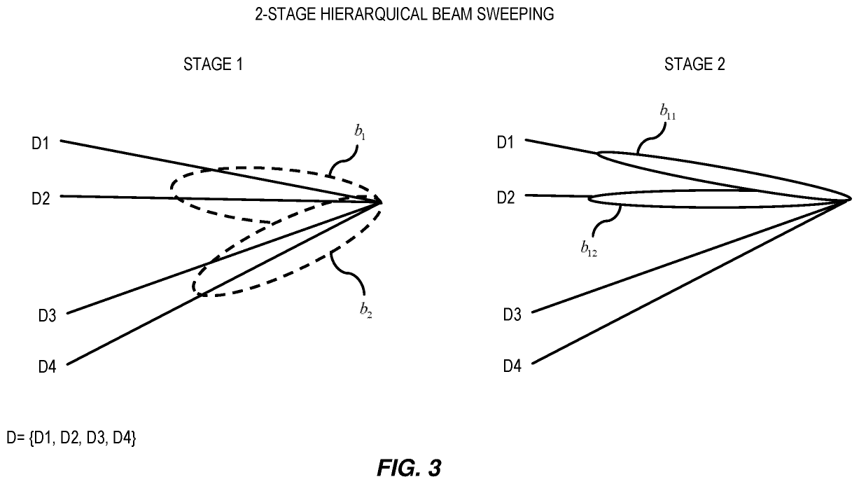

FIG. 3 illustrates an example of 2-stage hierarchical beam sweeping where beam b₁ is selected in the first stage. Once a wide beam is selected, a second pre-defined codebook comprising a set of narrower beams compared to those used in the previous stage is used. These narrow beams only span the angular range of the wide beam chosen in the previous stage. In this example, because beam b₁ was chosen in the first stage, a pre-defined codebook comprising beams b₁₁ and b₁₁ is used in the second stage. The beam refinement process may continue over additional stage stages until a very narrow beam is finally chosen in the final stage.

The selection of beams across the stages of the hierarchical beam sweeping procedure is typically conducted solely based on link gain/received power type of metrics, such as reference signal received power (RSRP). In the downlink direction, the UE 30 can perform beam selection based upon the transmission of synchronization signal blocks (SSBs), channel state information (CSI) reference signals (CSI-RS), or tracking reference signals (TRS). Beamforming coefficients applied to the set of SSBs can be used to generate relatively wide beams for initial acquisition. In contrast, beamforming coefficients applied to the set of CSI-RS resources can be used to generate more directional beams for subsequent beam refinement.

In the uplink direction, the access node 20 can perform beam selection based upon sounding reference signal (SRS) transmissions. If there is uplink/downlink beam correspondence, the beams selected for downlink transmission and reception can also be used for uplink transmission and reception.

It is not necessary for all physical channels to use the same beam. For example, the Physical Downlink Shared Channel (PDSCH) could use a directional high gain beam to help maximize throughput, while the Physical Downlink Control Channel (PDCCH) could use a wider beam to reduce the requirement for frequent switching between beams. The overhead associated with hierarchical beam sweeping is given by the sum of beams tested at each stage.

The overhead associated with standard hierarchical beam sweeping as shown in FIG. 3 is given by the sum of beams tested at each stage. For the above example, hierarchical beam sweeping does not yield an overhead reduction compared to traditional methods because the overhead (i.e., 2 stages×2 beams per stage=4 resources in total) equals the number of candidate directions of interest. However, beam configurations with a larger number of beams per stage than those of FIG. 3 typically yield overhead reductions.

In conventional beam sweeping, a codebook defines a set of beams to be measured at each stage of the beam sweeping procedure and measurements are performed for each predefined beam in the codebook. Because implementation of hierarchical beam sweeping is a proprietary feature, the specific shape of a “wide beam” used in an earlier stage, as well as the exact angular direction at which it is steered to, is a matter of choice. That said, a wide beam can be constructed in different ways, however, the angular profile of a wide beam used in an earlier stage should encompass the angular profile of all the narrow beams that are associated with it in the next stage (e.g. the angular spectrum of the wide beam b) should encompass the angular spectrum of the narrow beams b₁₁ and b₁₂). With this assumption, the construction of wide beams may take different forms. For example, a wide beam can be constructed according to 1) “array-size invariant beam-forming” techniques and its beam width and direction should be matched to the narrow beams it encompasses, or 2) can be more simply constructed via to linear combinations of the narrow beams it encompasses.

One problem with conventional state-of-the-art approaches to hierarchical beam sweeping is that the selection of a beam in a given stage of a hierarchical beam sweeping procedure is performed in isolation. Information for beam selection at stage n may exist in the received signals measured at stage n−1, but is typically not exploited. Another problem with state-of-the-art approaches to hierarchical beam sweeping is that the beam selection is typically conducted solely based on link gain/received power type of metrics.

One aspect of the disclosure comprises improvements in hierarchical beam sweeping to, after beam selection in the first stage, make use of information from previous stage(s) to perform beam selection in the current stage. In some embodiments, information from previous stages of the hierarchical beam sweeping procedure can be used to reduce the number of measurements required in the current stage. In other embodiments, information from previous stages of the hierarchical beam sweeping procedure can be used to improve the accuracy and reliability of the beam selection in the current stage.

For simplicity, the improvements in hierarchical beam sweeping are described in the context of a two-stage beam sweeping procedure with four directions of interest, D1-D4. Those skilled in the art will appreciate that the techniques herein described can be easily extended to any number of stages and any number or directions of interest. In the exemplary embodiments, the transmitter transmits multiple reference signals in the same transmit beam, which are measured by the receiver using a hierarchical beam sweeping procedure over the four directions of interest. In the first stage, the receiver performs beam sweeping and selects a “wide beam.” The techniques disclosed herein can be applied in any stage following the initial stage.

A predefined codebook Bₙ defines a set of Nₙ beams to be measured at stage n. The goal at stage n of the hierarchical beam sweeping procedure is to select the best beam from the set of Nₙ beams defined by the codebook Bₙ. Instead of scanning the Nₙ beams one-by-one, embodiments of the present disclosure scan linear combinations of the Nₙ beams in the predefined codebook Bₙ and perform measurements on reference signals received in the combined beams. One aspect of the disclosure is how to build these linear combinations to be measured in each stage after the first stage.

Because the techniques provided for the case Kₙ=Nₙ generalize straightforwardly for the case Kₙ<Nₙ and Kₙ>Nₙ, the case Kₙ=Nₙ is first explained for simplicity.

A signal model for the Kₙ measurements performed by a receiving node performing beam scanning at stage n, with n>1, of a hierarchical beam sweeping is given by:

$${y}_{n} = {( {B}_{n} {W}_{n} )}^{H} h + {n}_{n} \qquad Eq . ( l )$$

where h is a M×1 column vector representing the narrowband single-input multiple-output (SIMO) propagation channel, M is the number of antenna elements of the receiving node, and the Kₙ×1 column vector nₙ denotes additive noise.

The M×Nₙ matrix Bₙ contains the original beams of interest in its columns and M is the number of antenna elements of the receiving node. The columns of Bₙ may, for example, comprise vectors from a Discrete Fourier Transform (DFT) matrix. The task at stage n is to find which beams in Bₙ is best. Typically M>Nₙ when performing beam refinements procedures in large antenna arrays. Finally, the Nₙ×Kₙ matrix Wₙ is a weighting matrix containing weights for the linear combinations of beams to be measured at stage n. More concretely, the entries in the weighting matrix Wₙ can be seen as linear combining weights in the sense that they will dictate how the receiving node experiences the propagation channel h through the beams/columns of BₙWₙ. The length of the column vector, yₙ, namely Kₙ, is the number of measurements carried out, and therefore can be seen as the signaling overhead.

In standard hierarchical beam sweeping, each beam in the predefined codebook Bₙ is tested in isolation so the weighting matrix Wₙ=I, since each original beam is tested in isolation. That is, in standard hierarchical beam sweeping, each measurement is effectively performed with only one of the Nₙ beams in codebook Bₙ.

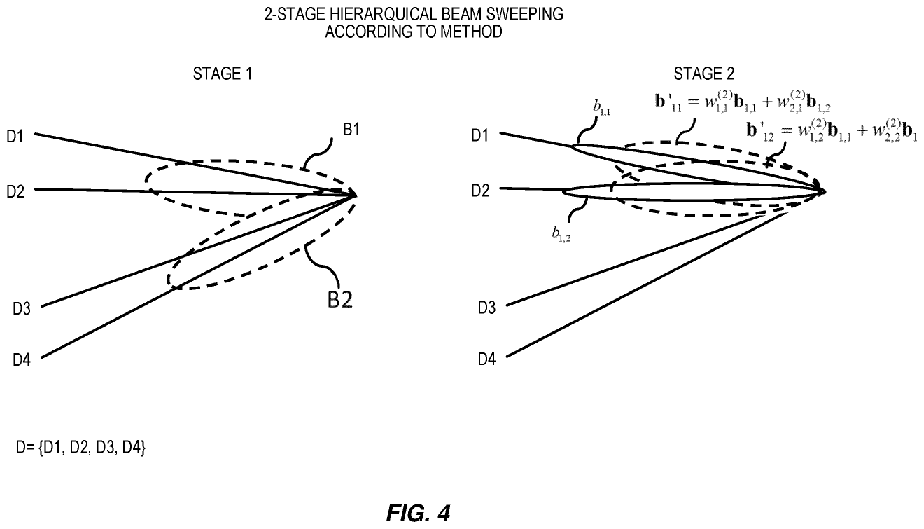

In embodiments where Kₙ=Nₙ, the number of columns in the weighting matrix Wₙ equals the number of rows. FIG. 4 illustrates exemplary beam patterns for measurement in the second stage assuming beam b₁ is selected in the first stage. In this example, the combined beams b′₁₁ and b′₁₂ are given by:

$${b}_{11}^{′} = {w}_{1 , 1}^{( 2 )} {b}_{1 , 1} + {w}_{2 , 1}^{( 2 )} {b}_{1 , 2} \qquad Eq . ( 2 )$$

$${b}_{12}^{′} = {w}_{1 , 2}^{( 2 )} {b}_{1 , 1} + {w}_{2 , 2}^{( 2 )} {b}_{1 , 2} \qquad Eq . ( 3 )$$

where the combining weights

$$\{ {w}_{1 , 1}^{( 2 )} , {w}_{1 , 2}^{( 2 )} , {w}_{2 , 1}^{( 2 )} , {w}_{2 , 2}^{( 2 )} \}$$

are given by the matrix:

$$W = [ \begin{matrix}{w}_{1 , 1}^{( 2 )} & {w}_{1 , 2}^{( 2 )} \\ {w}_{2 , 1}^{( 2 )} & {w}_{2 , 2}^{( 2 )}\end{matrix} ] \qquad Eq . ( 4 )$$

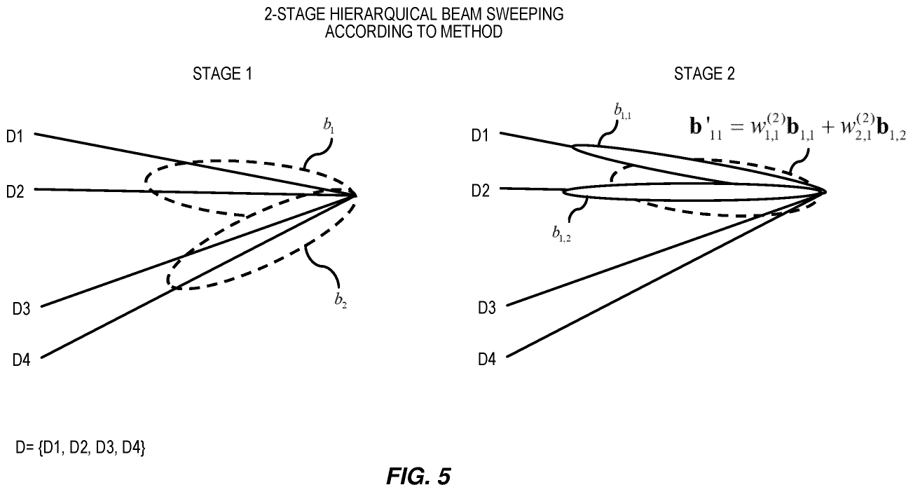

In embodiments where Kₙ<Nₙ, the weighting matrix Wₙ is constrained to have fewer columns than rows. The goal in this case is to reduce the numbers of measurements required for stage n. FIG. 5 illustrates exemplary beam patterns for measurement in the second stage assuming beam b₁ is selected in the first stage. In this example, the single combined beam b′₁₁ is given by:

$${b}_{11}^{′} = {w}_{1 , 1}^{( 2 )} {b}_{1 , 1} + {w}_{2 , 1}^{( 2 )} {b}_{1 , 2} \qquad Eq . ( 5 )$$

where the combining weights

$$\{ {w}_{1 , 1}^{( 2 )} , {w}_{1 , 2}^{( 2 )} , {w}_{2 , 1}^{( 2 )} , {w}_{2 , 2}^{( 2 )} \}$$

are given by the matrix:

$$W = [ \begin{matrix}{w}_{1 , 1}^{( 2 )} \\ {w}_{2 , 1}^{( 2 )}\end{matrix} ] \qquad ( Eq . ( 6 )$$

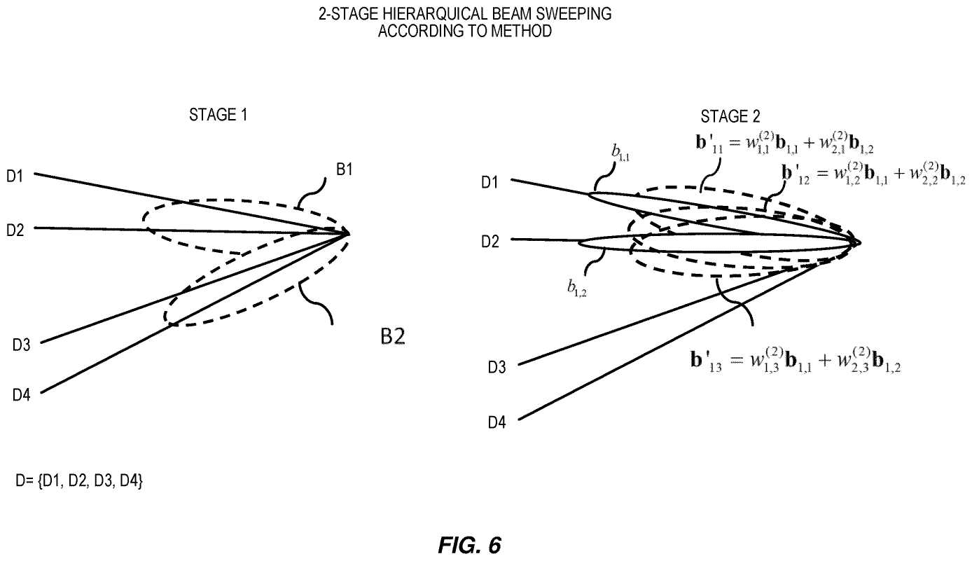

In embodiments where Kₙ>Nₙ, the weighting matrix Wₙ has more columns than rows. The goal in this case is to provide greater accuracy in beam selection by performing additional measurements. FIG. 6 illustrates exemplary beam patterns for measurement in the second stage assuming beam b₁ is selected in the first stage and Kₙ>Nₙ. In this example, the combined beams b′₁₁ and b′₁₂ are given by:

$${b}_{11}^{′} = {w}_{1 , 1}^{( 2 )} {b}_{1 , 1} + {w}_{2 , 1}^{( 2 )} {b}_{1 , 2} \qquad Eq . ( 7 )$$

$${b}_{12}^{′} = {w}_{1 , 2}^{( 2 )} {b}_{1 , 1} + {w}_{2 , 2}^{( 2 )} {b}_{1 , 2} \qquad Eq . ( 8 )$$

$$⋮$$

$${b}_{1 n}^{′} = {w}_{1 , n}^{( 2 )} {b}_{1 , 1} + {w}_{2 , n}^{( 2 )} {b}_{1 , 2} \qquad Eq . ( 9 )$$

where the combining weights

$$\{ {w}_{1 , 1}^{( 2 )} , {w}_{1 , 2}^{( 2 )} , {w}_{2 , 1}^{( 2 )} , {w}_{2 , 2}^{( 2 )} \}$$

are given by the matrix:

$$W = [ \begin{matrix}{w}_{1 , 1}^{( 2 )} & {w}_{1 , 2}^{( 2 )} & … & {w}_{1 , n}^{( 2 )} \\ {w}_{2 , 1}^{( 2 )} & {w}_{2 , 2}^{( 2 )} & … & {w}_{2 , n}^{( 2 )}\end{matrix} ] \qquad Eq . ( 10 )$$

### Previous Stage Measurements

In embodiments of the present disclosure, beam measurements performed in stage n are jointly processing with beam measurements made in one or more previous stages, e.g., stage n−1, in order to estimate the best beam among in the codebook Bₙ for the current stage.

Assume that

$${B}_{n - 1}^{*}$$

is a matrix whose columns represent combined beams measured in stage n−1 whose related measurements will be co-processed with the measurements at the stage n for beam selection. The system model for the measurements collected from previous stages and used in the current stage for beam selection is given by:

$${[ {y}_{1}^{T} … {y}_{n - 2}^{T} {y}_{n - 1}^{T} ]}^{T} = {[ {B}_{1}^{*} … {B}_{n - 2}^{*} {B}_{n - 1}^{*} ]}^{H} h + {[ {n}_{1}^{T} … {n}_{n - 2}^{T} {n}_{n - 1}^{T} ]}^{T} \qquad Eq . ( 11 )$$

Note that the measurements from previous stages that will be used to aid beam selection in the current stage can be viewed as observations from linear combinations of the codebook with the candidate beams in Bₙ. Therefore, the measurements made in previous stages contain information about the candidate beams which can be used to improve the beam detection performance. Such linear combinations may be represented by the matrices {A₁ . . . , Aₙ₋₂, Aₙ₋₁}. The relation between such matrices and the codebooks used at previous instances can be expressed as a linear relation according to:

$${B}_{n - k}^{*} = {B}_{n} {A}_{n - k} \qquad Eq . ( 12 )$$

where k>1. Equation 12 can be rewritten as:

$$\begin{matrix}{[ {y}_{1}^{T} … {y}_{( n - 2 )}^{T} {y}_{( n - 1 )}^{T} ]}^{T} = {[ {B}_{1}^{*} … {B}_{( n - 2 )}^{*} {B}_{( n - 1 )}^{*} ]}^{H} h + \\ {[ {n}_{1}^{T} … {n}_{( n - 2 )}^{T} {n}_{( n - 1 )}^{T} ]}^{T} \\ = {( {B}_{n} [ {A}_{1} … {A}_{( n - 2 )} {A}_{( n - 1 )} ] )}^{H} h + \\ {[ {n}_{1}^{T} ⋰ {n}_{( n - 2 )}^{T} {n}_{( n - 1 )}^{T} ]}^{T}\end{matrix} \qquad Eq . ( 13 )$$

In one embodiment, the measurements used from previous stages for beam selection in the current stage consist only of the single measurement associated with the beam selected in the previous stage. In the examples shown in FIG. 4-6, beam b₁ was selected in stage 1. Its related measurement is co-processed with the measurements performed in stage 2, i.e., measurements associated with beams b′₁₁ and b′₁₂, for detection of the best beam between b₁₁ or b₁₂. According to Eq. (13),

$$[ {B}_{1}^{*} … {B}_{n - 2}^{*} {B}_{n - 1}^{*} ] = {b}_{1}$$

for this example.

### Total System Model

Beam selection at stage n takes into account 1) the Kₙ measurements at the current stage represented by Equation (1), and 2) at least one measurement collected at previous stages represented by Equation (11). Thus, the general system model representing beam selection at stage n, is given by

$${[ {y}_{1}^{T} … {y}_{( n - 2 )}^{T} {y}_{( n - 1 )}^{T} {y}_{n}^{T} ]}^{T} = {( {B}_{n} [ {A}_{1} … {A}_{( n - 2 )} {A}_{( n - 1 )} {W}_{n} ] )}^{H} h + {[ {n}_{1}^{T} … {n}_{( n - 2 )}^{T} {n}_{( n - 1 )}^{T} {n}_{n}^{T} ]}^{T} \qquad Eq . ( 14 )$$

For best performance, the weighting matrix Wₙ needs to be optimized. The weighting matrix Wₙ is a function of 1) the set of Nₙ candidate beams represented by the columns of the matrix Bₙ and 2) the at least one beam measurements collected at previous stages,

$$[ {B}_{1}^{*} … {B}_{n - 2}^{*} {B}_{n - 1}^{*} ] .$$

Equation 14 shows that the channel between the transmitter and receiver will effectively be sensed by a measurement matrix given by:

Mₙ=Bₙ[A₁ . . . Aₙ₋₂Aₙ₋₁Wₙ] Eq. (15)

In Equation 15, the beam codebook of interest Bₙ is an M×Nₙ matrix. The weighting matrix Wₙ containing the weights to be optimized is an Nₙ×Kₙ matrix. The matrix [A₁ . . . Aₙ₋₂ Aₙ₋₁] is a Nₙ×ρ matrix where ρ represents the number of measurements from previous stages used in the current stage. In the examples shown in FIGS. 4-6 where the beam selected in at stage n−1 is the sole beam to be considered, p=1.

The columns of the measurement matrix Mₙ, are effectively the combined beams that the receiver will scan. These beams are linear combinations of the beams in the codebook of interest Bₙ. Some of these linear combinations were already defined by the measurements in the previous stages-namely through the effective beams Bₙ[A₁ . . . . Aₙ₋₂ Aₙ₋₁]. This essentially means that rank ([A₁ . . . . Aₙ₋₂ Aₙ₋₁]) dimensions of the subspace scanned by the columns of Bₙ were already “measured” in previous stages' measurements. For proper beam selection, a modified codebook Pₙ=BₙWₙ for stage n can be constructed such that it generates combined beams, i.e., linear combination of the beams in Bₙ, to scan the complementary Nₙ−rank ([A₁ . . . Aₙ₋₂ Aₙ₋₁]) dimensions of the beam subspace sampled by the measurements in previous stages. That is, the combined beams based on BₙWₙ should focus on sampling the complementary subspace of Bₙ[A₁ . . . Aₙ₋₂ Aₙ₋₁].

The matrix, [A₁ . . . Aₙ₋₂ Aₙ₋₁] is a “given” matrix so it cannot be optimized further for the measurements at stage n. There is, however, freedom to optimize the weighting matrix Wₙ so that the modified codebook Pₙ=BₙWₙ for stage n scans a subspace of the beam space that is complementary to the subspace scanned in stages. That is, the weighting matrix Wₙ is constructed so that Pₙ=BₙWₙ samples the complementary subspace of Bₙ[A₁ . . . Aₙ₋₂ Aₙ₋₁].

A receiver can perform detection of the best beam/column of Bₙ based n Eq. (14). For example, the receiver can equalize the weighting matrix [A₁ . . . Aₙ₋₂ Aₙ₋₁ Wₙ]]^{H} by filtering the measurements with [A₁ . . . Aₙ₋₂ Aₙ₋₁ Wₙ]^{H}]⁺ such as:

$${z}_{n} = {{[ {[ {A}_{1} ... {A}_{n - 2} {A}_{n - 1} {W}_{n} ]}^{H} ]}^{+} [ [ {y}_{1}^{T} ... {y}_{n - 2}^{T} {y}_{n - 1}^{T} ] {y}_{n}^{T} ]}^{T} = {B}_{n}^{H} h + {{[ {[ {A}_{1} ... {A}_{n - 2} {A}_{n - 1} {W}_{n} ]}^{H} ]}^{+} [ [ {n}_{1}^{T} ... {n}_{n - 2}^{T} {n}_{n - 1}^{T} ] {n}_{n}^{T} ]}^{T} \qquad Eq . ( 16 )$$

where

$${{[ {[ {A}_{1} ... {A}_{n - 2} {A}_{n - 1} {W}_{n} ]}^{H} ]}^{+} [ [ {n}_{1}^{T} ... {n}_{n - 2}^{T} {n}_{n - 1}^{T} ] {n}_{n}^{T} ]}^{T}$$

can be treated as additive post-processing noise.

Alternatively, post processing of the measurements can be performed by filtering the measurements with a regularized pseudoinverse of the weighting matrix. For example, the measurements can be filtered by:

([A₁ . . . A₍ₙ₋₂₎A₍ₙ₋₁₎Wₙ][A₁ . . . A₍ₙ₋₂₎A₍ₙ₋₁₎Wₙ]^{H}+εI)⁽⁻¹⁾[A₁ . . . A₍ₙ₋₂₎A₍ₙ₋₁₎Wₙ] Eq. (17)

where ε is a conveniently chosen scalar. For example, ε can be chosen to be equal to 1/ [symbol] , where [symbol] is an estimate of the signal-to-noise ratio.

Based on the post-processed measurements

$${z}_{n} = [ {z}_{1 , ... ,}^{( n )} {z}_{{N}_{n}}^{( n )} ] ,$$

the receiver may then estimate the index of the best beam. For example, by defining the best beam as the index of the column of Bₙ yielding the largest received signal strength indicator (RSSI), the receiver may estimate the index of best beam at stage n, namely \hat{k}ₙ, as:

$${\hat{k}}_{n} = \begin{matrix}arg max \\ k\end{matrix} {\vert {z}_{k}^{( n )} \vert}^{2} \qquad Eq . ( 18 )$$

In another embodiment, the receiver may instead estimate the index of the best beam at stage n by considering some probability function (e.g., posterior distribution of zₙ) taking into account both the prior distribution of the noise and the equalization process by [A₁ . . . Aₙ₋₂ Aₙ₋₁ Wₙ]^{H}]⁺. Then, a statistically optimal beam index can be selected by selecting the index that maximize a desired criterion, one example of which may be the maximum a posteriori (MAP) estimate.

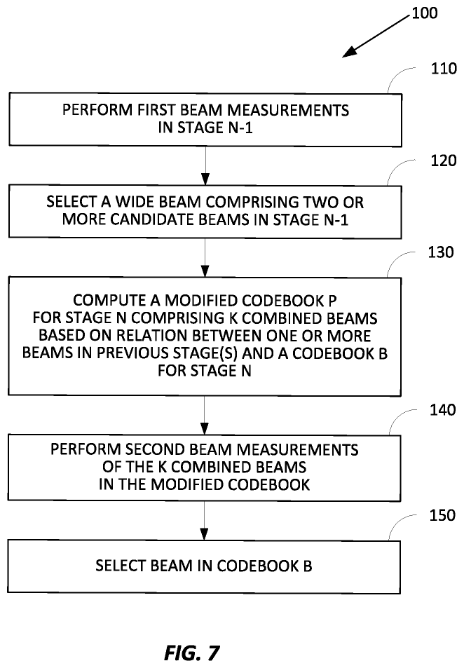

FIG. 7 illustrates a generalized beam sweeping method 100 according to embodiments of the present disclosure. The method 100 can be performed in any stage after the first stage where relatively wide beams are transmitted in stage n−1 or earlier stages and narrower beams falling in the angular range of the wide beams are transmitted in stage n. The receiver (e.g., UE 30 or access node 20) performs first beam measurements in stage n−1 (block 110) and selects a wide beam in stage n−1 (block 120). The wide beam comprises a linear combination of two or more candidate beams from which to select a beam for a transmission. The receiver computes a reduced codebook P for stage n comprising K beams to be measured based on a relation between the selected wide beam in stage n−1 and a codebook B for stage n comprising K′>K beams (block 130). In stage n, the receiver performs second measurements of the K combined beams in the reduced codebook P (block 140). The receiver then selects the “best” beam in codebook B in terms of signal strength or signal quality based the first and second measurements (block 150).

With this background in mind, two example embodiments are described in more detail below. In the first example, the number of measurements Kₙ to be performed in stage n is less than the number of beams in the predefined codebook Bₙ. In this example, measurements from previous stages are used to reduce the number of measurements that need to be performed at stage n. In the second example, the number of measurements to be performed in stage n is greater or equal to the number of beams in the predefined codebook Bₙ In this example, measurements from previous stages are used to improve beam selection performance.

### Example 1: K<N

In this example, measurements to be performed in stage n>1 are reduced by reusing at least one measurement made at stage n−1 (or an earlier stage). The reused measurement(s) from stage n−1 can be thought of as an observation of a linear combination of the set beams to be measured at stage n because the beams at stage n−1 are wider and b₁₁ design cover the directions of multiple nth stage beams. Knowledge of the relation of the measurement(s) made in stage n−1 with the codebook for stage n enables beam selection in stage n with fewer measurements. Thus, the number of beam measurements performed in stage n, namely K, is smaller than the cardinality of the subset of targeted directions D′ (or the cardinality of the codebook Bₙ).

FIG. 5 illustrates two-stage hierarchical beam sweeping with four directions of interest. In this example, the UE 30 performs hierarchical beam sweeping over a set of target directions D1-D4. The access node 20 transmits a reference signal and the UE 30 measures the reference signal in each candidate receive beam. Those skilled in the art will appreciate that the roles of the UE 30 and access node 20 could be reversed with the UE 30 transmitting a reference signal (e.g., SRS) and the access node 20 performing the reference signal measurements in the candidate receive beams.

The main goal of the UE 30 is to infer which of the 4 target directions, namely D1, D2, D3 and D4, provides the best link for communication (e.g., provides the highest path gain). The entire set of target directions of interest is D′={D1, D2, D3, D4}. In the first stage, two wide beams were scanned, namely b and b₂. Beam b₂ is wide in the sense it covers the subset of target directions {D1,D2}, and beam b₂ is wide in the sense that it covers the subset of target directions {D3,D4}.

In the example of FIG. 5, it is assumed that beam b₁ was the selected beam at a first stage based on measurement of received signal power or other signal quality. Example signal quality measurements include reference signal received [power (RSRP), reference signal received quality (RSRQ) signal to interference plus noise ratio (SINR, etc. These measurements are performed on reference signals transmitted in the candidate beams. In the downlink direction, the signals measured could be SSBs or CSI-RS.

For the second stage, the subset of the targeted directions at stage n related to the beam selected at stage n−1 is D={D1, D2} corresponding to candidate beams b₁₁ and b₁₂ as shown in FIG. 5. The goal of the UE 30 at the stage n is to find the direction in D that provides the best link quality. Because there is one candidate beam per target direction of interest (a one-to-one mapping as shown in FIG. 2), the goal at the stage n is to determine which of the two candidate beams b₁₁ or b₁₂ provides the best link in terms of signal power and/or signal quality.

Denote the N beams to be evaluated in the nth stage of a hierarchical beam sweeping procedure by the M×N weighting matrix Bₙ=[b₁, . . . , b_{N}], where each column of B represents the beamforming weights associated with one of the candidate beams b₁₁ and b₁₂, and M denotes the number of receiving antennas. The goal of the UE 30 at the second stage is to evaluate which of the columns of the weighting matrix Bₙ is the best at stage n.

In traditional hierarchical beam sweeping, the N beams in Bₙ would be tested one-by-one in the second stage, thus requiring N measurements in the second stage to infer which of the N columns of Bₙ is the best. For example, the received signal strength measured with beam 11 would be compared with that of beam b₁₂, and the beam with larger associated received signal strength would be chosen. This type of approach uses no prior knowledge in the testing and evaluation of beams b₁₁ and b₁₂. Therefore, the training overhead of the entire 2-stage hierarchical procedure would be 4 reference signal measurements: 2 for stage n−1 and 2 for stage n. In the traditional method, the overhead associated with training at stage n is equal to the cardinality of the subset of targeted directions D′={D1, D2}, namely 2.

As previously noted, information for the selection of the candidate beam in the nth stage is available from at least one of the measurements collected at stage n−1. This prior knowledge of measurements at stage n−1 can be used to reduce the number of measurements at stage n. In the example shown in FIG. 5, the measurement of the reference signal transmitted in b₁ can be thought of as an observation of a linear combination of the candidate beams b₁₁ and b₁₂ to be evaluated at stage n. This is a reasonable assumption based on the fact that the beams at stage n−1 are wider and b₁₁ design span the angular directions of the nth stage candidate beams.

Denoting the weights of one such linear combination by the N×1 column vector a, the relation between the beam selected at stage n−1, namely

$${B}_{n - 1}^{*} ,$$

and the codebook of interest Bₙ, is given by:

$${B}_{n - 1}^{*} = {B}_{n} a \qquad Eq . ( 19 )$$

where

$${B}_{n - 1}^{*}$$

is the way wide beam selected at stage n−1. and the column vector a provides two coefficients that represent the superposition of beams b₁ and b₂ present in the measurement at stage n−1.

In the example of FIG. 5, only two observations are required to be able to estimate which of the two beams b₁ and b₂ in Bₙ is best. Therefore, only one additional measurement (other than the measurement associated with

$${B}_{n - 1}^{*}$$

is required at stage n to select the best beam at stage n. More generally, the number of measurements required for stage n equals N−m where N is the cardinality of the codebook B at stage n and m is the number of measurements available from stage n−1 or previous stage.

Returning to the example in FIG. 5, a single combined beam denoted b′₁₁ is constructed for measurement at stage n. This combined beam b′₁₁ as a linear combination of beams b₁₁ and b₁₂ This measurement of b′₁₁ made at stage n is then used along with the measurement made of the selected beam

$${B}_{n - 1}^{*}$$

at stage n−1 to select the best beam at stage n. Thus, the number of measurements that need to be performed at stage n to be able to solve the problem at hand is N=1, which is smaller than the cardinality of the codebook Bₙ. This solution requires coherent processing between the measurements at both stages, thus the propagation channel should preferably remain invariant across measurements made in different stages. If more than one wide beam measurement at the stage n−1 has a significant projection into Bₙ, the number of measurements N can be lower than N−1.

The next issue is the construction of beams for the reduced measurement set with K<N measurements. Denote such reduced codebook by Pₙ with dimensions M×K. Conducting beam measurements with this reduced codebook Pₙ, in conjunction with the measurement in the first stage based on

$${B}_{n - 1}^{*} ,$$

allows the detection of the best beam in B. More specifically, the effective codebook can be written as:

$$[ \begin{matrix}{B}_{n - 1}^{*} & {P}_{n}\end{matrix} ] = {B}_{n} [ \begin{matrix}a & {W}_{n}\end{matrix} ] \qquad Eq . ( 20 )$$

The M×N effective codebook

$$[ \begin{matrix}{B}_{n - 1}^{*} & P\end{matrix} ]$$

can be viewed as a sensing matrix, in which signals will be measured in order to detect the best beam in Bₙ. There is some freedom in designing how to linearly combine beams in the second stage, i.e., there is some freedom to optimize the weighting matrix Wₙ. In the example shown in FIG. 5, Wₙ is a M×1 column vector because only a single beam measurement is used from the previous stage.

One aspect of the disclosure is to find the reduced codebook Pₙ for stage n with lower overhead than the codebook Bₙ. In the current disclosure, the reduced codebook Pₙ is a function ƒ(·) of the original codebook Bₙ as well as the selected beam used

$${B}_{n - 1}^{*}$$

from the first stage, namely:

$${P}_{n} = f ( {B}_{n - 1}^{*} , {B}_{n} ) \qquad Eq . ( 21 )$$

In the example of FIG. 5, Bₙ is a M×2 matrix, and thus the new codebook P is an M×1 column vector. The beams utilized in the measurements at stage n, which in the current example is a single beam represented by the column vector P, provides information about the original codebook Bₙ. Each beam in Pₙ comprises a linear combination of the beams in Bₙ given by:

Pₙ=BₙWₙ Eq. (22)

where the weighting matrix Wₙ contains the combination coefficients for the beams in codebook Bₙ. This column vector Wₙ is a parameter vector subject to optimization, and thus can be designed. With that, the effective codebook for stage n, denoted Mₙ, can be written as:

$${M}_{n} = [ \begin{matrix}{B}_{n - 1}^{*} & {P}_{n}\end{matrix} ] = {B}_{n} [ \begin{matrix}a & {W}_{n}\end{matrix} ] \qquad Eq . ( 23 )$$

Another aspect of the disclosure provides a solution for the columns of Wₙ for optimization of the measurements at stage n. In one embodiment, the solution for the columns of Wₙ correspond to a set of orthonormal vectors spanning the orthogonal complement of the column(s) of a. An outcome of this design is that the measurements obtained from signals received from the effective codebook

$$[ \begin{matrix}{B}_{n - 1}^{*} & {P}_{n}\end{matrix} ]$$

can be efficiently translated into the basis of interest, namely, without noise enhancement, therefore not impacting performance when detecting the best beam in Bₙ.

Looking at the measurement carried out at stage n−1 with beam

$${B}_{n - 1}^{*}$$

as the first observation, and the second measurement carried out with the single beam Pₙ in as the second observation, the resulting system model can be written as:

$$y = {M}_{n}^{H} h + {n [ {B}_{n} [ \begin{matrix}a & {W}_{n}\end{matrix} ] ]}^{H} h + n \qquad Eq . ( 24 )$$

where h is the narrowband propagation channel, and n denotes noise.

Ideally, if there was complete freedom to optimize both a and Wₙ the set [a Wₙ]=I would allow observation of h via the weighting matrix Bₙ. However, there is freedom to optimize Wₙ only. Nevertheless, if a [Wₙ] is a unitary matrix, the signal observations can be efficiently rotated to another set of basis without noise enhancement. This rotation is given by:

$$z = {[ \begin{matrix}{z}_{1} & {z}_{2}\end{matrix} ]}^{T} = [ \begin{matrix}a & {W}_{n}\end{matrix} ] y = {B}_{n}^{H} h + \tilde{n} \qquad Eq . ( 25 )$$

Equation 25 provides essentially the same performance/setup as in the traditional full-beam sweep, since the resulting noise vector ñ=[Wₙ^{H} a^{H}] n has the same statistical distribution as H the noise vector n in Equation 24.

Based on Equation 25, the following procedure can be used to optimize the columns of Wₙ and ensure that [a Wₙ] is a unitary matrix:
1. Compute the inner product/projection of \hat{b}ⁿ⁻¹ into Bₙ, as

e=B^{H}\hat{b}ⁿ⁻¹ Eq. (26)
2. Perform a Singular Value Decomposition of ee^{H}, namely ee^{H}=UΛV^{H}, where U=[u₁ . . . u_{K}], Λ=diag(σ₁, . . . , σ_{K}) and σ₁≥σ₂≥ . . . ≥σ_{K}.
3. Denote U′ as the matrix containing in its columns the left singular vectors associated with singular values with zero amplitude in its columns, i.e. U′=[uₖ . . . u_{K}] where σₖ=0 but σₖ₋₁≠0.
4. Assign U′ to the parameter vector to be optimized, namely Wₙ=U′

The above procedure, or other equivalent procedures, provides a very suitable setting for Wₙ since the columns of U′ can be seen as the orthogonal complement to the column vector a. With that guarantee that [a Wₙ] is a unitary matrix and therefore no noise enhancement during the detection of the best beam based on z=[z₁ z₂]^{T}.

For completeness, estimation of the best beam can then be performed based on Equation 25 by choosing beam b₁₁ if |z₁|>|z₂], of choosing b₁₂ otherwise.

In simulations, hierarchical beam sweeping as herein described has been compared to traditional beam sweeping methods. The setup for the simulation is the same as shown in FIG. 5, i.e., a 2-stage hierarchical beam sweeping. For simplicity we assume n=1, and thus the two stages are stage 1 and stage 2. To simplify the simulations, it is assumed that the beam at stage 1 is chosen correctly, e.g., b₁ was selected, and the simulations thus focus on stage 2. More specifically, the simulations focus on the choice of the narrow beams (e.g., b₁₁ and b₁₂).

The receiver has an M=16 antenna elements. The narrow beams, i.e., b₁₁, b₁₂ in FIG. 5, comprise 2 columns of a Discrete Fourier Transform (DFT) matrix F=[ƒ₁ . . . ƒ_{M}]. Each column vector of F is normalized to have unit energy

$$( i . e . {f}_{m}^{H} {f}_{m} = 1. )$$

Two narrow beams are modeled in the weighting matrix Bₙ, namely Bₙ=[ƒₚ ƒₚ₊₁]. The index p (which is implicitly associated with the beams' direction) was randomized during every simulation run.

The wide beam chosen at stage 1, i.e., b), was chosen to be a weighted sum of their two associated narrow beams. That is

$${B}_{n - 1}^{*} = {w}_{1} {f}_{p} + {w}_{2} {f}_{p + 1} \qquad Eq . ( 27 )$$

where |w₁|²+|w₂|²=1. The simulations used equal weighting w₁=w₂ just like the second stage beam B′11 in FIG. 5. Other configurations {w₁, and w₂} for the beams may be used, but the results of the simulations do not change as a function of w₁ and w₂.

The propagation channel h is modeled via its contributions/projection to the codebook of interest Bₙ via h=Bₙp, where the two entries of p=[p₁ P₂]^{T} are zero-mean circularly-symmetric complex-valued Gaussian random variables and

E{p^{H}p}=1, Eq. (28)

where E{·} denotes the expectation operator.

The simulations compare the average energy of the effective channel obtained from the inner product between the propagation channel h and the best narrow beam chosen ƒ_{\hat{k}}, namely the average “specular” channel gain E{|hƒ_{\hat{k}}|²}, where averaging takes place over all sources of randomness of the model. Such channel gain is plotted against signal to noise ratio (SNR), which is here defined to be the inverse of the variance of each entry of the random vector n, in Equation 19, with identically and independent distributed circularly-symmetric zero-mean complex-Gaussian entries.

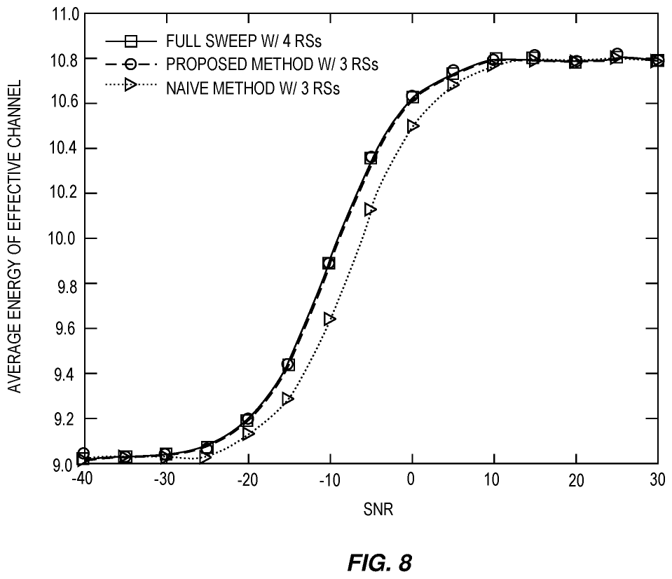

FIG. 8 shows the average effective channel gain versus SNR for 1) a traditional (i.e. full) beam sweep, 2) the disclosed method where Wₙ is optimized as herein described, and 3) a naive approach using a single measurement of one of the narrow beam of interest (e.g., b₁₁) in the second stage. The naive method makes one beam measurement selects the measured beam if the measurement meets a predetermined criteria and otherwise selects the other beam. For the naïve approach, Wₙ=[1 0]^{T} instead of the disclosed optimized setting, which degrades performance.

At low SNR, which corresponds to a random pick out of the two beams, the three methods perform the same. The average energy of the effective channel is thus, 10*log (M)−3 dB=10*log (16)−3 dB=9.0412 dB as shown in the figure. (The −3 dB factor results from the fact than, from eq. (6), each channel path has ½ energy in average). The average energy of the effective channel gain saturates at high SNR for all methods-here the best beam is chosen at all times. The plots converge to about 10*log 10 (M)+10*log 10 (0.7477)=10.7784, where 0.7477≈E{max({p₁}², {p₂}²)}.

Both the preferred method using a combined beam in the second stage as well as the naïve method, require 3 measurements in total: two measurements to infer the best wide beam at stage 1, plus one additional measurement to infer the best narrow beam at stage 2. The full beam sweep according to traditional methods, in contrast, requires 4 measurements in total: 2 measurements to infer the beam wide beam at stage 1, plus 2 additional measurements to infer the best narrow beam in the second stage.

The naive method yields a performance degradation with respect to the two other methods. This is because the setting of the beam weighting matrix [a C] does not offer an optimized (orthonormal) set of coefficients that allows the best sampling of the column space of the codebook of interest B.

On the other hand, both the traditional full beam sweep method and the disclosed method perform exactly the same. The reason for this result is that the beam weighting matrix is a unitary matrix for both methods (for the case of traditional beam sweeping it is an identify matrix-one beam is tested at a time). Thus, for the 2-stage hierarchical beam sweeping case, the disclosed method provides equal beam scanning performance but uses 1¾=25% less resources compared to traditional full beam sweeping methods. It also provides improved performance over the naïve approach that tries to achieve beam scanning of 4 beams in 3 resources.

### Example 2: K>N

In this example, Kₙ measurements are performed in stage n>1, where Kₙ is greater than or equal to the number of beams of interest in the codebook Bₙ. Instead of scanning each of the Nₙ beams defined by the codebook Bₙ one-by-one, beam measurements are performed on linear combinations of these Nₙ beams. Further, beam measurements from previous states are reused to improve beam selection performance.

FIG. 6 illustrates two-stage hierarchical beam sweeping with four directions of interest. The transmitter may, during the entire beam sweeping procedure, be transmitting RSs in the same transmit beam or antenna element. The multiple transmitted RSs will be measured by the Rx during an RX beam sweeping procedure. Those skilled in the art will appreciate that the roles of the UE 30 and access node 20 could be reversed with the UE 30 transmitting a reference signal (e.g., SRS) and the access node 20 performing the reference signal measurements in the candidate receive beams.

As previously noted, the beam constructions based on Bₙ Wₙ should focus on sampling the complementary subspace of Bₙ[A₁ . . . Aₙ₋₂ Aₙ₋₁]. A second aspect to consider is that the number of columns of BₙWₙ, namely the Kₙ beam measurements at stage n, may be larger than the number of beam subspace dimensions to be sampled, namely Nₙ−rank([A₁ . . . Aₙ₋₂ Aₙ₋₁]).

These considerations are addressed by using an extended total m-squared correlation cost (TSC) function. The solution to the standard total m-squared correlation cost (TSC) function is generally known as a Grassmannian matrix, say the M₁×M₂ matrix G with M₂>M₁. Such a matrix packs M₂ unit-length vectors in a M₁-dimensional subspace. Obviously, the (unit-length) rows of G, namely

$${\{ {g}_{j} \}}_{j = 1}^{{M}_{2}} ,$$

cannot all be mutually orthogonal since there are more vectors than dimensions. Building G by minimizing the total m-squared correlation

$$TSC = {\sum }_{i = 1 , j = 1}^{{M}_{2}} {\vert {g}_{j} {g}_{i}^{H} \vert}^{2 m}$$

sets up these M₂ unit-length vectors such that the sum of the m-squared cross-correlations between vectors are minimized (e.g. m=1 minimizes the sum of squared Frobenious norms). If one adds a, so-called Grassmannian, constraint to the TSC minimization, then the cross-correlations between all possible pairs of M₂ unit-length vectors can be made equal and the smallest possible—this is the same as ensuring that the principal angle between all pairs of vectors is the same and the largest possible. Note that optimization software packages (e.g., MatLab) have packages/libraries that can find suitable approximate solutions for the TSC problem are available.

In one embodiment, the solution to optimize Wₙ is based on a cost function which can be seen as an extended version of the TSC cost function. Namely, defining [A₁ . . . Aₙ₋₂ Aₙ₋₁]=[a₁ . . . aₚ] and the weighting matrix

$${W}_{n} = [ {w}_{1}^{( n )} ... {w}_{{K}_{n}}^{( n )} ] ,$$

our extended TSC cost function, namely eTSC cost function is:

$$eTSC = {\sum }_{i = 1 , j = 1}^{{K}_{n}} {\vert {( {w}_{i}^{( n )} )}^{H} {w}_{j}^{( n )} \vert}^{2 m} + {\sum }_{i = 1}^{p} {\sum }_{j = 1}^{{K}_{n}} {\vert {a}_{i}^{H} {w}_{j}^{( n )} \vert}^{2 m} \qquad Eq . ( 29 )$$

where the first summation resembles the original TSC cost function, and the second summation is added to fit the problem at hand.

The rationale for the construction of the above eTSC cost function is as follows. The second summation ensures that the measurements performed at stage n are made of linear combination of beams which result in significantly different measuring beams compared to those beams measured in previous stages, and the first term of the summation ensures that these measurements are as distinct as possible from each other in order to effectively obtain uniform sampling of the beam subspace (which translates into better detection performance as it will be shown in the sections below).

In a final embodiment, either the first term or the second term or both in Equation 29 can be rescaled by considering multiplicative weights. For instance, introducing a parameter λ∈[0,1] can further generalize the eTSC in Equation 29 as

$$eTSC = λ {\sum }_{i = 1 , j = 1}^{{K}_{n}} {\vert {( {w}_{i}^{( n )} )}^{H} {w}_{j}^{( n )} \vert}^{2 m} + ( 1 - λ ) {\sum }_{i = 1}^{p} {\sum }_{j = 1}^{{K}_{n}} {\vert {a}_{i}^{H} {w}_{j}^{( n )} \vert}^{2 m} \qquad Eq . ( 30 )$$

where notice that Equation 30 boils down to the conventional TSC by setting λ=1 and λ can be tuned based on, e.g., the measured SNR values at the previous stages.

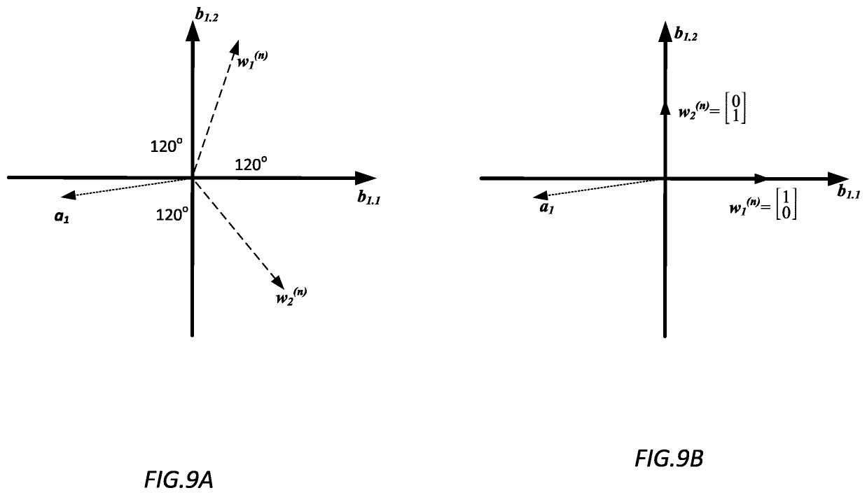

FIG. 9A provides an intuitive explanation why the extended TSC is a suitable cost function for the beam measurements. FIG. 9 illustrates how the solution looks like for the simple case of FIG. 3. In this example, the solutions for the entries of

$${w}_{1}^{( n )} , {w}_{2}^{( n )}$$

and a₁ are real-valued (so that we are able to visualize the solution in a 2D plot), but note that the extended TSC cost function accommodates solutions with complex-valued entries.

In FIG. 9A, the two beams to be chosen at stage n are beams b₁₁ and b₁₂. One linear combination of these beams was measured at the previous stage—that linear combination is defined by the two entries of the 2×1 vector a₁. The solution to the eTSC cost function is illustrated by the two dashed vectors, with associated weight vectors

$${w}_{1}^{( n )} and {w}_{2}^{( n )} .$$

In sum, the solution distributed the two vectors across the two real-dimensions such that the maximum principal angle between all measurement related weights (i.e., the one of the previous stage, and the two of the current stage) is maximized—it equals 120 degrees. In this way, the measurements oversample the beam subspace in an uniform way which, as it will be seen in the simulations, results in better detection performance.

For completeness, FIG. 9B shows the naïve case of using predefined weight configurations for the weights of the measurements done at stage n, regardless of the weight setting of the previous stage's measurement. In the first stage, n measurement samples only beam b₁₁, and the second stage n measurement samples only beam b₁₂. Here, the configuration of the measurements done at stage n does not depend on the beam chosen in the previous stage.

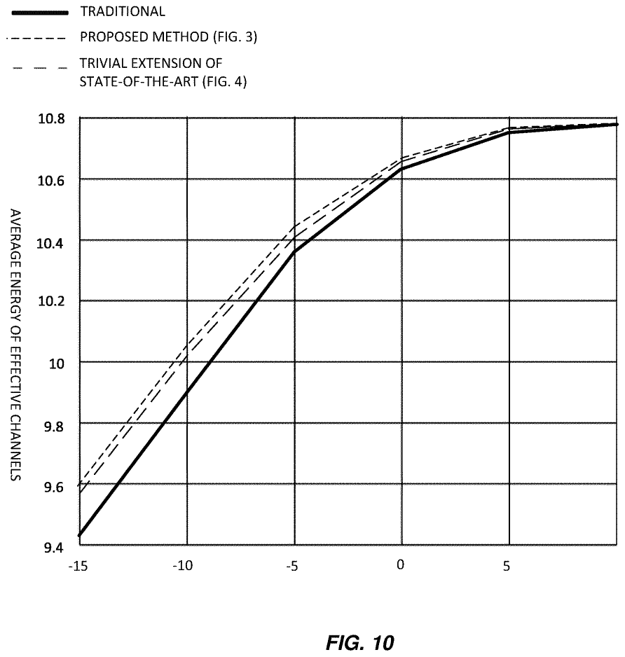

FIG. 10 illustrates simulation results for a two-stage beam sweeping procedure as herein described. To simplify the simulations, the beam at stage 1 is assumed to be chosen correctly, e.g., b₁ was chosen, and the simulations focuses on stage 2. More specifically, the simulations focus on the selection of the narrow beams themselves (e.g., by and b₁₂).

The receiver has an M=16 antenna array. The narrow beams, i.e. b₁₁, b₁₂ in FIG. 6, consists of 2 consecutive columns of a DFT matrix F=[ƒ₁ . . . ƒ_{M}]. (Each column vector of F is normalized to have unit energy, i.e.

$${f}_{m}^{H} {f}_{m} = 1. )$$

Two narrow beams are modeled in the weighting matrix Bₙ, namely, Bₙ=[ƒₚƒₚ₊₁]. The index p (which is implicitly associated with the beams' direction) is randomized every simulation run.

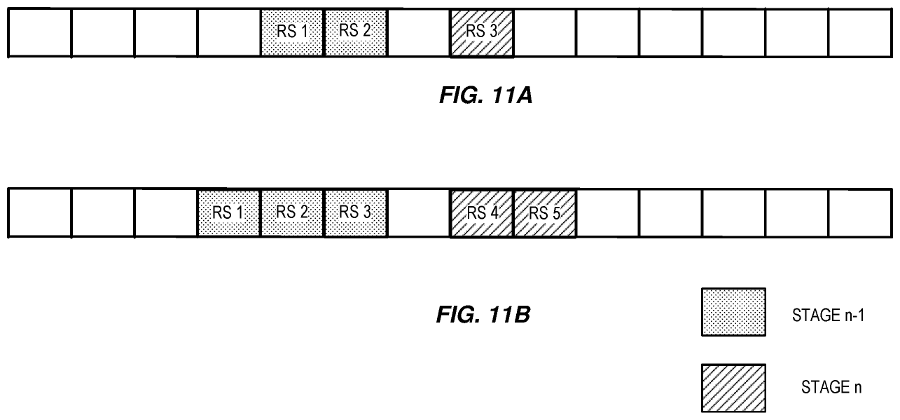

The wide beam chosen at stage 1, i.e., b₁, is chosen to be a weighted sum of their two associated narrow beams. That is:

$${B}_{n - 1}^{*} = {w}_{1} {f}_{p} + {w}_{p + 1} \qquad Eq . ( 31 )$$

where |w₁|²+|w₂|²=1. In the simulations, equal weighting, i.e. w₁=w₂=\sqrt{0.5} was used Other configurations for {w₁, and w₂} beams may take place, but the results presented in FIG. 11 do not change as a function of w₁ and w₂ (as long as |w₁|²+|w₂|²=1)

The propagation channel h is modeled via its contributions/projection to the codebook of interest Bₙ (since other contributions are not sensed by the array anyway) via h=Bₙp, where the two entries of p=[p₁ p₂]^{T} are zero-mean circularly-symmetric complex-valued Gaussian random variables and

E{p^{H}p}=1 (Eq. (32)

where E{·} denotes the expectation operator.

The simulations compare the (averaged) energy of the effective channel obtained from the inner product between the propagation channel h and the narrow beam chosen ƒ_{\hat{k}}, namely the average “specular” channel gain E{|hƒ_{\hat{k}}|²}, where averaging takes place over all sources of randomness of the system model. Such channel gain is plotted against SNR, which is here defined to be the inverse of the variance of each entry of the additive noise random vector n_{k′}, with identically and independent distributed circularly-symmetric zero-mean complex-Gaussian entries.

FIG. 10 contains three plots. One plot shows the performance of the traditional beam sweeping method which measures each of the two second stage beams in isolation, and then performs beam detection solely based on these 2 measurements That is, it does beam selection using solely the 2 measurements performed on the second stage. Another plot shows the beam selection performance which results from jointly post-processing the measurement associated with the beam selected in stage 1 with the 2 measurements carried out at stage 2, but where the beam weights associated with measurements at stage 2 are constructed according to FIG. 4. Said differently, the beam weights related to the 2 measurements carried out at stage 2 are not optimized based on the measurement/beam selected at stage 1. The third plot shows the beam selection performance resulting from the current disclosure, which consists of jointly post-processing the measurement associated with the beam selected in stage 1 with the 2 measurements carried out at stage 2, but the beam weights related to the measurements done at stage 2 are optimized according to the current disclosure-see FIG. 3

As a sanity check, it can be seen that the average energy of the effective channel gain saturates at high SNR for all methods-here the best beam is chosen at all times. The three plots converge to about 10*log 10 (M)+10*log 10 (0.7477)=10.7784, where 0.7477≈E{max({p₁}²,{p₂}¹)}.

From FIG. 10, it can also be seen that is a generally good idea to reuse measurements from previous stages in the current stage's beam selection. More importantly, we see that when doing so, there are performance gains that result from optimizing the beam weights related to the measurements of the current stage based on the beam which was selected in the previous stage—as we elaborated in this invention. More specifically, the dotted line is shifted to the left compared to the dashed curve by about 0.5 dB. These gains, which are moderate but that come at an additional cost of additional signal post processing, motivate the methods provided in the current disclosure.

The techniques herein described require joint coherent processing (in amplitude and phase) of the signal measurements at stage n−1 and stage n. Therefore, the modified codebooks described herein are best used in propagation scenarios where the channel coherence time and/or bandwidth is larger than the coherence time and/or bandwidth required to transmit signals in subsequent stages of a hierarchical beam sweep. The techniques may be carried out either utilizing time-multiplexed versions of the same reference signal configuration (e.g., a specific CSI RS configuration), or it could potentially also be executed with different reference signals or with different configurations of the same reference signal.

The reference signals can be any of the SSB, CSI-RS, or TRS. The receiver (e.g., UE 30 or access node 20) can choose to follow only one type of reference signal for the whole procedure or a combination. For example, in a first stage, the UE 30 may measure the SSB but in a second stage measure the CSI-RS. In some cases, the UE 30 may need to be aware of the power offset of different reference signals, and this information can be obtained from configuration information.

In one embodiment, the receiver (UE 30 or access node 20) performs a measurement, or receives a report, concerning the coherence time/bandwidth of the link. Coherence time/bandwidth can be estimated, for example, by analyzing the correlation between subsequent channel estimates obtained on the basis of measurements on a demodulation reference signal (DMRS). Alternatively, coherence time/bandwidth can be indicated to the UE 30 by the network. In one embodiment, the channel coherence/bandwidth is indicated by means of a downlink control channel signaling, if the receiver is a UE 30. The receiver is also informed on the entire time that comprises two subsequent stages of the hierarchical beam scanning procedure. Here one can distinguish two cases:

When the receiver is an access node 20 that performs explicit receive (Rx) beam training (i.e., it does not rely on beam correspondence). In this case, the access node 20 will perform a hierarchical beam scanning procedure by measuring on a periodic, semi-persistent or aperiodic uplink reference signal (e.g. SRS in 5G New Radio (NR)). The periodicity of the UL reference signal is known to the access node 20 because the parameters of the UL reference signal are configured by the network; The access node 20 can also use other type of potential reference signals, e.g., reference signals included as part of a PUSCH signal, such as DMRS.

When the receiver is a UE 30 that performs explicit Rx beam training, the UE 30 knows the periodicity of the periodic/semi-persistent/aperiodic downlink reference signal (e.g., CSI-RS or SSB) used for hierarchical beam scanning because the parameters of the downlink reference signal have been communicated to the UE 30 as part of the DCI, or system information (SI). The UE 30 can also use other available reference signals within the channel coherence time window, e.g., DMRS included as part of a PDSCH signal for example. Essentially, the UE 30 can see the number of available reference signal stages within the channel coherence time, and decide to perform the beam training as disclose herein if the number of reference signals, and beams and stages are sufficient for this approach.

If the receiver detects that the coherence time of the channel is larger than the time it takes to execute 2 subsequent stages, the receiver may use the method herein described. Otherwise, it may not activate the disclose method and perform a traditional full beam scanning procedure instead.

FIGS. 11A and 11B illustrate reference signal transmission showing how the disclosed method could be carried out within an NR slot. An NR slot with 14 consecutive orthogonal frequency division multiplexing (OFDM) symbols, is used as an example in FIGS. 11A and 11B. FIG. 11A illustrates signaling for a 2-stage hierarchical beam sweeping with two candidate beams in each stage where K<N. In this example, the 2 reference signals for measurements in the first stage are transmitted in the 5^{th} and 6^{th} symbols while the reference signal for the single measurement in the second stage is transmitted in the 8^{th} symbol. FIG. 11B illustrates reference signal transmission for a 2-stage hierarchical beam sweeping with three candidate beams in each stage where K<N. In this example, the 3 reference signals for measurements in the first stage are transmitted in the 4th-6^{th} symbols while the t2 reference signals for measurement in the second stage are transmitted in the 8^{th} and 9^{th} symbols.

As shown in FIGS. 11A and 11B, one or more OFDM symbols signals may be used as a gap between stage n−1 and stage n. Such gap may be used for processing of the received signals at stage n−1, and for selection of which stage n−1 beam is the best.

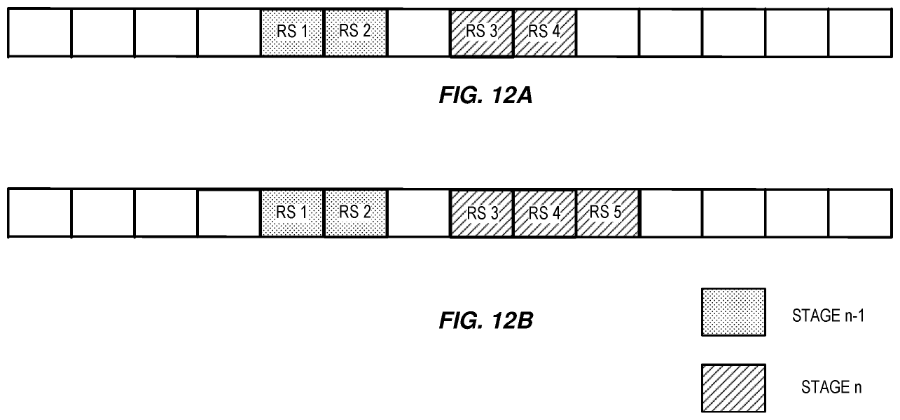

FIG. 12A illustrates reference signal transmission for a 2-stage hierarchical beam sweeping with two candidate beams in each stage where K=N measurements are made in the second stage. In this example, the 2 reference signals for measurements in the first stage are transmitted in the 5^{th} and 6^{th} symbols and two reference signals are transmitted in the 7^{th} and 8th symbols for the second stage.

FIG. 12B illustrates reference signal transmission for a 2-stage hierarchical beam sweeping with two candidate beams in each stage where K>N measurements are made in the second stage. In this example, the 2 reference signals for measurements in the first stage are transmitted in the 5^{th} and 6^{th} symbols and three reference signals are transmitted in the 7th-9th symbols for the second stage.

In some embodiments, the receiver may indicate the preferred structure of reference signals transmitted by the transmitter that are used for the measurements during the hierarchical sounding procedure. In one example, the receiver may indicate to the transmitter the periodicity/time between subsequent transmissions of the transmitted reference signal so that the time between subsequent two stages of the sounding procedure is smaller than the coherence time of the channel. In another example, the receiver may indicate to the transmitter the number of repetitions of the transmitted reference signal necessary for completing the sounding procedure. In still another embodiment, the receiver may indicate the beams of interest in each stage. The receiver can also indicate on an aperiodic basis the need for new reference signals.

Signaling of a preferred structure for the reference signals may depend on whether the receiver is the UE 30 or access node 20. Where the receiver is an access node and performs explicit beam Rx beam training (i.e., it does not rely on beam correspondence), the network may configure the UE to transmit the uplink reference signals (e.g. SRS) with a periodicity smaller than the coherence time of the channel in case of periodic/semi-persistent SRS, or in case of aperiodic SRS, it can configure the time between subsequent reference signals to be smaller than the channel coherence time. In case of semi-persistent and aperiodic SRS, the number of repetitions/transmissions of the SRS can be configured according to the necessary number of measurements. In the example illustrated in FIGS. 4-6, the SRS could be configured for 3 repetitions/transmissions. Indications of SRS structure (periodicity, no. of repetitions) are part of standard downlink control communication using either Medium Access Control (MAC) Control Elements (MAC-CEs) or DCI.

Where the receiver is a UE 30 that performs explicit Rx beam training, the UE 30 can indicate the periodicity of the downlink reference signals (e.g., CSI-RS) necessary for two subsequent reference signal transmissions to fit within a channel coherence time. Also, the UE 30 can indicate the number of repetitions/transmissions of the downlink reference signals necessary to complete the beam scanning procedure. The downlink reference signals (e.g., CSI-RS) may be semi-persistent or aperiodic. UE 30 can indicate the structure of downlink reference signals as part of uplink control information. Currently, the NR standard does not allow the UE 30 to configure or indicate preference on the structure of downlink reference signals, so this approach would require an update to the existing standard.

Some examples below illustrate how the UE 30 can indicate the structure of the reference signals, but these same techniques can be applied to the access node 20 as well. In one embodiment, the UE 30 transmits the above-mentioned requirements to the network through PUCCH or PUSCH signaling. Alternatively, the UE 30 can indicate its preference through UE assistance information. The UE 30 can be explicitly configured to perform this task, or pre-configured based on a condition in standardization, e.g., when the channel coherence time is large enough. Additional conditions can also apply, e.g., when the UE 30 is not mobile or when the channel quality e.g., SINR is larger than a threshold.

In another embodiment, UE 30 can indicate to the network its preferred beams in one or more stages. For example, UE 30 may be provided with a configured set of beams, or potential beams as hypothesis in each stage, and the UE 30 can indicate its preference to the network on periodic or aperiodic basis. For example, the UE 30 may receive a first and a second beam in the first stage, and based on the outcome of the first stage, the UE 30 can indicate its preference for a third beam for the second stage.

In another embodiment, UE 30 can indicate its need for new reference signals transmissions in the next slot, or another time unit on aperiodic basis. This can be done, for example, through a scheduling request on PUCCH or PUSCH.

The beam selection techniques described herein enable hierarchical beam sweeping with less measurements per stage. Compared to traditional hierarchical beam sweeping procedures, the beam selection techniques as herein described have lower training overheads; lower control plane latency, and with lower energy consumption because fewer measurements are performed. For example, in a 2-stage beam sweep with 2 beams per stage (as shown in FIGS. 4-6, the best narrow beam can be selected using 3 measurements compared to 4 measurements as in hierarchical beam sweeping; a 25% overhead reduction, and also reduces the energy spent in reference signal measurements. Even greater savings can be achieved when more than 2 beams are tested per stage.

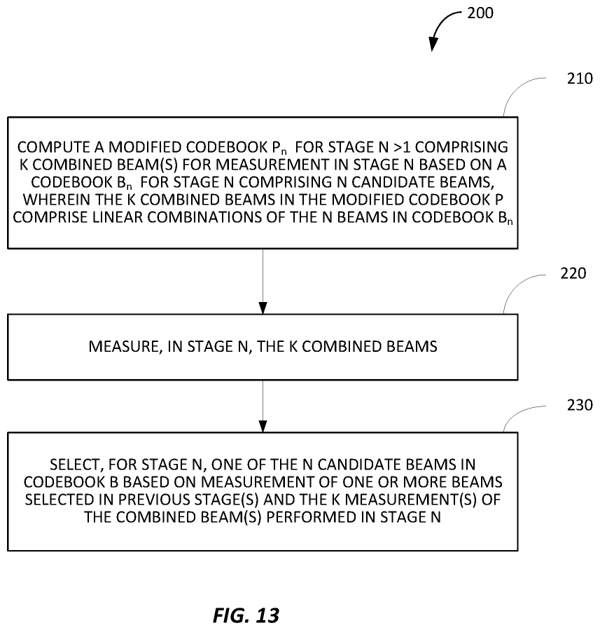

FIG. 13 illustrates a procedure 200 performed by a receiver to select a beam at stage n of a hierarchical beam sweep procedure using a modified codebook as herein described. The receiver computes a modified codebook Pₙ for a stage n>1 comprising K combined beam(s) based on a codebook Bₙ for stage n comprising N beams, wherein the K combined beams comprise linear combinations of the N beams in codebook Bₙ (block 210). The receiver is further configured to, in a stage n, measure the K combined beam(s) (block 220). The receiver is further configured to select, for stage n, one of the N beams in codebook Bₙ based on a measurement of one or more beams performed in one or more previous stages and the K measurement(s) of the combined beam(s) performed in the stage n (block 230).

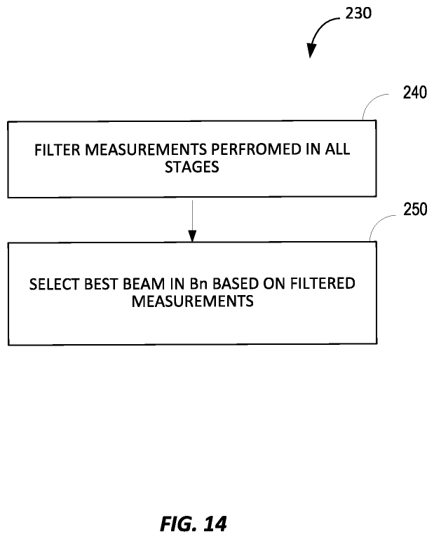

FIG. 14 illustrates an example procedure implemented at block 230 in FIG. 13 for selecting the best beam in codebook B based on the first and second measurements. The receiver filters the first and second measurements performed in stage n and the previous stages (block 240). The receiver then selects one of the beams in codebook B based on the filtered measurements (block 250).

In some embodiments of the method 200, computing the modified codebook P for stage n comprises computing the modified codebook P as a function of a relation between the one or more beams selected in the previous stage(s) and the codebook B for stage n.

In some embodiments of the method 200, the one or more combined beams sample a complementary subspace of the beam space sampled in the previous stage(s).

In some embodiments of the method 200, computing the modified codebook P comprises computing, based on the function, a weighting matrix W for combining the N candidate beams in codebook B to generate the K combined beams.

In some embodiments of the method 200, the function is an extended total m-squared correlation (TSC) cost function.

In some embodiments of the method 200, the TSC cost function includes a first minimization term to minimize cross-correlations between the combined beams.

In some embodiments of the method 200, the TSC cost function includes a second minimization term to minimize cross-correlations between the combined beams being measured in stage n and the selected beams from the previous stages.

In some embodiments of the method 200, the cost function includes first and second scaling parameters to scale the first and second minimization terms respectively.

In some embodiments of the method 200, the weighting matrix Wₙ comprises a Grassmannian frame.

In some embodiments of the method 200, K>N. In other embodiments, K<N. In still other embodiments, K=N.

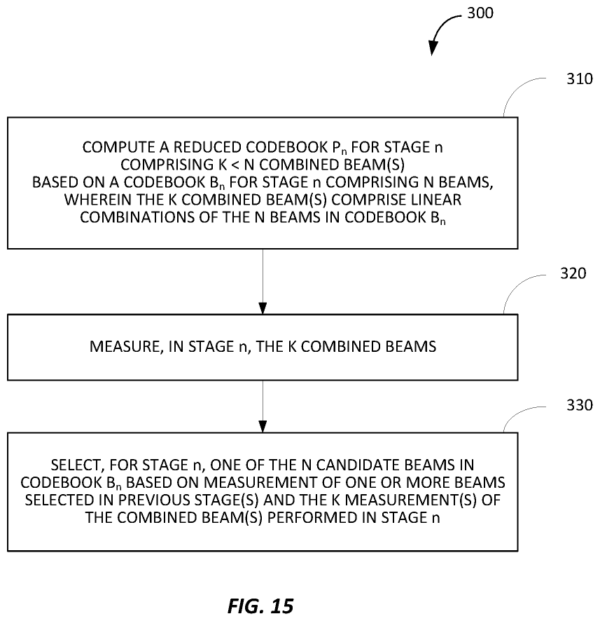

FIG. 15 illustrates a procedure 300 performed by a receiver to select a beam at stage n of a hierarchical beam sweep procedure using a reduced codebook Pₙ. The receiver computes a reduced codebook Pₙ for a stage n comprising K combined beam(s) based on a codebook Bₙ for stage n comprising N>K beams, wherein the K combined beams comprise linear combinations of the N beams in codebook Bₙ (block 310). The receiver is further configured to, in a stage n, measure the K combined beam(s) (block 320). The receiver is further configured to select, for stage n, one of the N candidate beams in a full codebook Bₙ based on a measurement of one or more beams performed in previous stage(s) and the K measurement(s) of the combined beam(s) performed in the stage n (block 330).

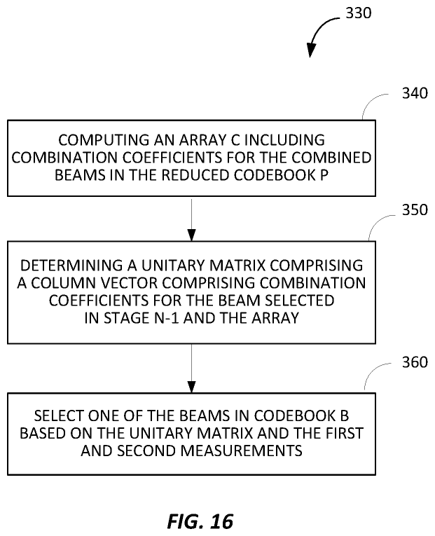

FIG. 16 illustrates an example procedure implemented at block 330 in FIG. 15 for selecting the best beam in codebook Bₙ based on the first and second measurements. The receiver computes a weighting matrix Wₙ including combination coefficients for the beams in codebook Bₙ to obtain the set of combined beams in the reduced codebook P (block 340). The receiver further comprises a unitary matrix comprising a column vector including combination coefficients for the beam selected in stage n−1 and the weighting matrix Wy. (block 350). The receiver then selects one of the beams in codebook Bₙ based on the unitary matrix and the first and second measurements (block 360).

In some embodiments of the method 300, computing the effective codebook Pₙ for stage n comprises computing the reduced codebook Pₙ based on a relation between the selected beam from the previous stage and the codebook Bₙ.

In some embodiments of the method 300, the combining weights for the K combined beams are a function of the orthogonal complement of the inner product between the beam selected in the previous stage and the K′ beams in codebook Bₙ.

In some embodiments of the method 300, selecting, in stage n, one of the beams in codebook Bₙ comprises computing an weighting matrix Wₙ including combination weights for the K combined beams in the reduced codebook Pₙ, determining a unitary matrix comprising a column vector comprising combination weights for the selected beam and the array. And selecting one of the candidate beams in the second stage based on the unitary matrix and the measurements.

Some embodiments of the method 300 further comprise determining a channel coherence time of a channel between the receiver and a transmitter of the candidate beams, and performing the method to reduce beam measurements responsive to determining that the channel coherence time is sufficient to maintain channel coherence for the beam measurements in different stages during the beam sweeping procedure.

Some embodiments of the method 300 further comprise indicating, to a transmitter of the candidate beams, a time interval between reference signals transmitted for beam measurement in different stages such that the time interval is less than a channel coherence time.

Some embodiments of the method 300 further comprise indicating to a transmitter a number of repetitions of reference signals needed for beam measurements.

Some embodiments of the method further comprise indicating to a transmitter a number of candidate beams of interest for at least one stage.

Some embodiments of the method 300 further comprise indicating to a transmitter on an aperiodic basis a need for new beam measurements.

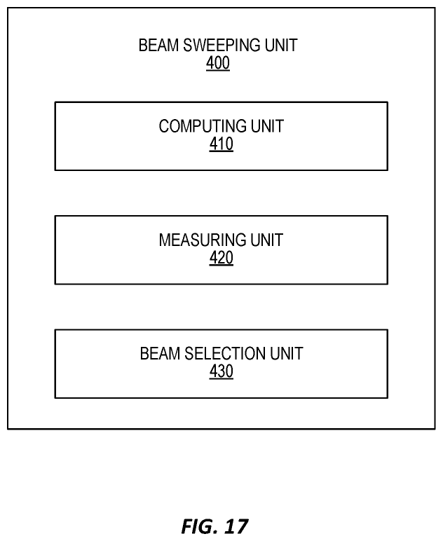

FIG. 17 illustrates a beam sweeping unit 400 for a receiver configured to perform hierarchical beam sweeping as herein described. The beam sweeping unit 400 comprises a computing unit 410, a measuring unit 420 and a beam selection unit 430. The various unit 410-430 can be implemented by hardware and/or by software code that is executed by one or more processors or processing circuits. The computing unit 410 is configured to compute a modified codebook P for a stage n>1 comprising K combined beam(s) based on a codebook B for stage n comprising N beams, wherein the K combined beams comprise linear combinations of the N beams in codebook B. The measuring unit 420 is configured to, in a stage n, measure the K combined beam(s). The beam selection unit 430 is configured to select, for stage n, one of the N beams in codebook B based on one or more first measurements of one or more beams performed in one or more previous stages and K second measurement(s) of the combined beam(s) performed in the stage n.

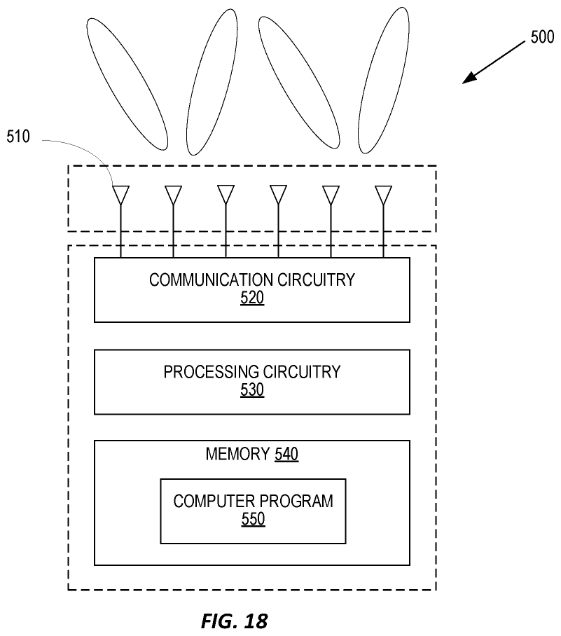

FIG. 18 illustrates a receiver 400 configured for enhanced scaling as herein described. The receiver 400 comprises communication circuitry 520, processing circuitry 530, and memory 540. The communication circuitry 520 comprises a radio frequency (RF) circuitry coupling to one or more antenna 510 for transmitting and receiving signals over a wireless communication channel. In one embodiment, the RF circuitry may comprise a RF transceiver including an RF transmitter and RF receiver configured to operate according to 5G standards.

The processing circuitry 530 controls the overall operation of the receiver 400. The processing circuitry 530 may comprise one or more microprocessors, hardware, firmware, or a combination thereof. In exemplary embodiments, the processing circuitry 530 is configured to perform hierarchical beam sweeping as herein described. In one embodiment, the processing circuitry 530 is configured to perform any one of the methods 100, 200, and 300 shown in FIGS. 7, 13 and 15 respectively.

Memory 540 comprises both volatile and non-volatile memory for storing computer program code and data needed by the processing circuitry 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuit 530 in the receiver 400 to perform any one of the methods 100, 200, and 300 shown in FIGS. 7, 13 and 15 respectively. A computer program 550 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

Those skilled in the art will also appreciate that embodiments herein further include corresponding computer programs 550. A computer program 550—comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

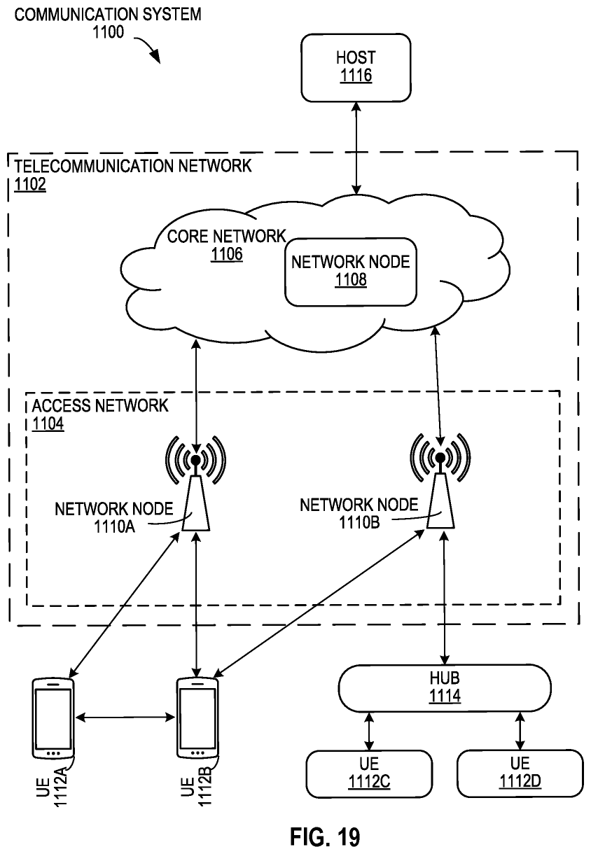

FIG. 19 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

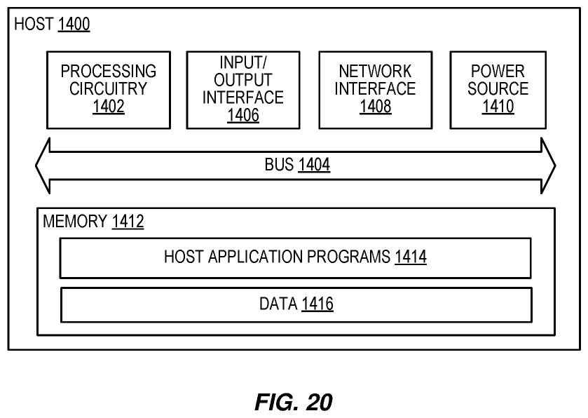

FIG. 20 is a block diagram of a host 1400, which may be an embodiment of the host 1116 of FIG. 19, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE.

Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

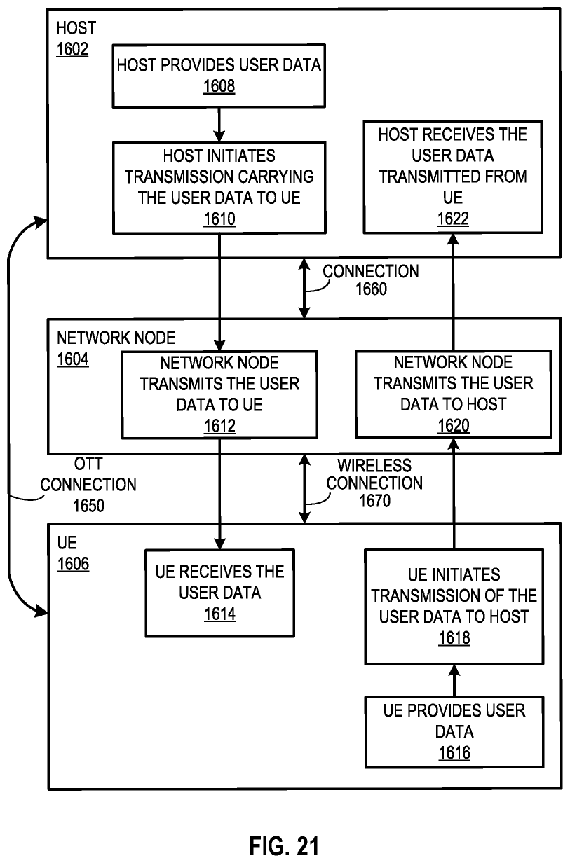

FIG. 21 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 19), network node (such as network node 1110a of FIG. 19), and host (such as host 1116 of FIG. 19 and/or host 1400 of FIG. 13) discussed in the preceding paragraphs will now be described with reference to FIG. 20.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 19) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the connection latency and thereby provide benefits such as reduced waiting times and better user experience.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

In an exemplary embodiment, a host is configured to operate in a communication system to provide an over-the-top (OTT) service. The host comprises processing circuitry configured to initiate receipt of user data and a network interface configured to receive the user data from a network node in a cellular network, the network node having a communication interface and processing circuitry. The processing circuitry of the network node is configured to perform the following operations to receive the user data from the UE for the host:
compute a reduced codebook P for stage n comprising K<K′ combined beam(s) based on a codebook B for stage n comprising K′ beams, wherein the K combined beams comprise linear combinations of the K′ beams in codebook B;
measure, in stage n, the K combined beam(s); and
select, for stage n, one of the K′ beams in codebook B based on a measurement of a beam selected in a previous stage and the K measurement(s) of the combined beam(s) performed in stage n.

In some embodiments of the host, the processing circuitry of the host is configured to execute a host application, thereby providing the user data, and the host application is configured to interact with a client application executing on the UE, the client application being associated with the host application.

In some embodiments of the host, initiating receipt of the user data comprises requesting the user data.

Other embodiments comprise methods implemented by a host configured to operate in a communication system that further includes a network node and a user equipment (UE). The method comprises, at the host, initiating receipt of user data from the UE, the user data originating from a transmission which the network node has received from the UE. The network node performs the following operations to receive the user data from the UE for the host:
compute a reduced codebook P for stage n comprising K<K′ combined beam(s) based on a codebook B for stage n comprising K′ beams, wherein the K combined beams comprise linear combinations of the K′ beams in codebook B;
measure, in stage n, the K combined beam(s); and
select, for stage n, one of the K′ beams in codebook B based on a measurement of a beam selected in a previous stage and the K measurement(s) of the combined beam(s) performed in stage n.

Some embodiments of the method further comprise, at the network node, transmitting the received user data to the host.

Another embodiment of the disclosure comprises a host configured to operate in a communication system to provide an over-the-top (OTT) service. The host comprises processing circuitry configured to provide user data and a network interface configured to initiate transmission of the user data to a cellular network for transmission to a user equipment (UE). The UE comprises a communication interface and processing circuitry, the communication interface and processing circuitry of the UE being configured to perform the following operations to receive the user data from the host:
compute a reduced codebook P for stage n comprising K<K′ combined beam(s) based on a codebook B for stage n comprising K′ beams, wherein the K combined beams comprise linear combinations of the K′ beams in codebook B;
measure, in stage n, the K combined beam(s); and
select, for stage n, one of the K′ beams in codebook B based on a measurement of a beam selected in a previous stage and the K measurement(s) of the combined beam(s) performed in stage n.

In some embodiments of the host, the cellular network further includes a network node configured to communicate with the UE to transmit the user data to the UE from the host.

In some embodiments of the host, the processing circuitry of the host is configured to execute a host application, thereby providing the user data, and the host application is configured to interact with a client application executing on the UE, the client application being associated with the host application.

Another embodiments comprises methods implemented by a host operating in a communication system that further includes a network node and a user equipment (UE). The method comprises providing user data for the UE, and initiating a transmission carrying the user data to the UE via a cellular network comprising the network node, wherein the UE performs the following operations to receive the user data from the host:
compute a reduced codebook P for stage n comprising K<K′ combined beam(s) based on a codebook B for stage n comprising K′ beams, wherein the K combined beams comprise linear combinations of the K′ beams in codebook B;
measure, in stage n, the K combined beam(s); and
select, for stage n, one of the K′ beams in codebook B based on a measurement of a beam selected in a previous stage and the K measurement(s) of the combined beam(s) performed in stage n.

Some embodiments of the method further comprise at the host, executing a host application associated with a client application executing on the UE to receive the user data from the UE.

Some embodiments of the method further comprise, at the host, transmitting input data to the client application executing on the UE, the input data being provided by executing the host application, wherein the user data is provided by the client application in response to the input data from the host application.

1-19. (canceled)

20. A method performed by a radio network node of performing beam measurements during hierarchical beam sweeping, the method comprising:
computing a modified codebook P for stage n>1 comprising K combined beam(s) for measurement in stage n based on a codebook B for stage n comprising N candidate beams, wherein the K combined beams in the modified codebook P comprise linear combinations of the N beams in codebook B;
measuring, in stage n, one or more of the K combined beam(s); and
selecting, for stage n, one of the N candidate beams in codebook B based on measurement of one or more beams performed in one or more previous stage(s) and the K measurement(s) of the combined beam(s) performed in stage n.

21. The method of claim 20, wherein computing the modified codebook P for stage n comprises:
computing the modified codebook P as a function of a relation between the one or more beams measured in the previous stage(s) and the codebook B for stage n.

22. The method of claim 21, wherein the one or more combined beams sample a complementary subspace of a beam space sampled in the previous stage(s).

23. The method of claim 21, wherein computing the modified codebook P comprises computing, based on the function, a weighting matrix W for combining the N candidate beams in codebook B to generate the K combined beams.

24. The method of claim 21, wherein the function is an extended total m-squared correlation (TSC) cost function.

25. The method of claim 24, wherein the TSC cost function includes a first minimization term to minimize cross-correlations between the combined beams being measured in stage n.

26. The method of claim 24, wherein the TSC cost function includes a second minimization term to minimize cross-correlations between the combined beams being measured in stage n and the measured beams from the previous stages.

27. The method of claim 26, wherein the cost function includes first and second scaling parameters to scale the first and second minimization terms respectively.

28. The method of claim 24, wherein the weighting matrix W comprises a Grassmannian frame.

29. The method of claim 20, where K>N.

30. The method of claim 20, where K<N.

31. The method of claim 20, where K=N.

32. A radio network node configured to perform hierarchical beam sweeping, the radio network node comprising:
communication circuitry for communicating with another radio network node using beamforming; and
processing circuitry operatively connected to the communication circuitry, the processing circuitry being configured to:
compute a modified codebook P for stage n>1 comprising K combined beam(s) for measurement in stage n based on a codebook B for stage n comprising N candidate beams, wherein the K combined beams in the modified codebook P comprise linear combinations of the K′ beams in codebook B;
measure, in stage n, one or more of the K combined beam(s); and
select, for stage n, one of the N candidate beams in codebook B based on measurement of one or more beams performed in one or more previous stage(s) and the K measurement(s) of the combined beam(s) performed in stage n.

33. The radio network node of claim 32, wherein computing the modified codebook P for stage n comprises:
computing the modified codebook P as a function of a relation between the one or more beams measured in the previous stage(s) and the codebook B for stage n.

34. The radio network node of claim 33, wherein the one or more combined beams sample a complementary subspace of a beam space sampled in the previous stage(s).

35. The radio network node of claim 33, wherein computing the modified codebook P comprises computing, based on the function, a weighting matrix W for combining the N candidate beams in codebook B to generate the K combined beams.

36. The radio network node of claim 33, wherein the function is an extended total m-squared correlation (TSC) cost function.

37. The radio network node of claim 36, wherein the TSC cost function includes a first minimization term to minimize cross-correlations between the combined beams being measured in stage n.

38. The radio network node of claim 36, wherein the TSC cost function includes a second minimization term to minimize cross-correlations between the combined beams being measured in stage n and the measured beams from the previous stages.

39. The radio network node of claim 38, wherein the cost function includes first and second scaling parameters to scale the first and second minimization terms respectively.

40. A non-transitory computer-readable storage medium (540) containing a computer program comprising executable instructions that, when executed by a processing circuit in a user equipment in a wireless communication network causes the user equipment to:
compute a modified codebook P for stage n>1 comprising K combined beam(s) for measurement in stage n based on a codebook B for stage n comprising N candidate beams, wherein the K combined beams in the modified codebook P comprise linear combinations of the K′ beams in codebook B;
measure, in stage n, one or more of the K combined beam(s); and
select, for stage n, one of the N candidate beams in codebook B based on measurement of one or more beams performed in one or more previous stage(s) and the K measurement(s) of the combined beam(s) performed in stage n.
